(19) United States
(12) Patent Application Publication
(10) Pub. No.: US 2026/0214485 A1
(43) Pub. Date: Jul. 23, 2026

(54) TECHNIQUES FOR NETWORK ANALYTICS EXPOSURE FROM A CORE NETWORK OF A WIRELESS COMMUNICATIONS SYSTEM

(71) Applicant: QUALCOMM Incorporated, San Diego, CA (US)

(72) Inventors: Juan ZHANG, Beijing (CN); Hong CHENG, Basking Ridge, NJ (US); Stefano FACCIN, San Ysidro, CA (US)

(21) Appl. No.: 19/137,992

(22) PCT Filed: Feb. 6, 2023
(86) PCT No.: PCT/CN2023/074520

§ 371 Date: Jun. 11, 2025

(51) Int. Cl. H04W 24/10; H04L 41/0894; H04L 41/142; H04L 41/147; H04L 41/16

(52) U.S. Cl. CPC H04W 24/10; H04L 41/0894; H04L 41/142; H04L 41/147; H04L 41/16

(57) ABSTRACT

Methods, systems, and devices for wireless communication are described. A first device may receive a first message from a second de-Network Core vice that indicates multiple set identifiers (IDs) associated with network analytics of a core network of a wireless communications system. Each set ID of the multiple set IDs may correspond to a respective operation and a respective set of parameters. The first device may transmit a second message to a third devices that indicates a request for network analytics associated with a set ID of the multiple set IDs. The request may be in accordance with the respective operation and the respective set of parameters that correspond to the set ID. In response to the request, the first device may receive a third message from the third device that indicates the network analytics associated with the respective operation and the respective set of parameters that correspond to the set ID.

### CROSS REFERENCE

The present Application is a 371 national phase filing of International PCT Application No. PCT/CN2023/074520 by ZHANG et al., entitled “TECHNIQUES FOR NETWORK ANALYTICS EXPOSURE FROM A CORE NETWORK OF A WIRELESS COMMUNICATIONS SYSTEM,” filed Feb. 6, 2023, which is assigned to the assignee hereof, and which is expressly incorporated by reference in its entirety herein.

### FIELD OF TECHNOLOGY

The following relates to wireless communication, including techniques for network analytics exposure from a core network of a wireless communications system.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more network entities, each supporting wireless communication for communication devices, which may be known as user equipment (UE).

### SUMMARY

The described techniques relate to improved methods, systems, devices, and apparatuses that support techniques for network analytics exposure from a core network of a wireless communications system. For example, the described techniques may provide a framework for exposing network analytics to an application layer of a protocol stack at a first device. The first device may receive a first message from a second device that indicates multiple set identifiers (IDs) associated with the network analytics of the core network of the wireless communications system. In such an example, each set ID of the multiple set IDs may correspond to a respective operation and a respective set of parameters. The first device may transmit a second message to a third devices that indicates a request for network analytics associated with a set ID of the multiple set IDs. The request may be in accordance with the respective operation and the respective set of parameters that correspond to the set ID. In response to the request, the first device may receive a third message from the third device that indicates the network analytics associated with the respective operation and the respective set of parameters that correspond to the set ID.

A method for wireless communication at a first device is described. The method may include receiving, from a second device, a first message that indicates a set of multiple set IDs associated with network analytics of a core network of a wireless communications system, where each set ID of the set of multiple set IDs corresponds to a respective operation and a respective set of parameters, transmitting, to a third device, a second message that indicates a request for network analytics associated with a set ID of the set of multiple set IDs in accordance with the respective operation and the respective set of parameters that correspond to the set ID, and receiving, from the third device in response to the request, a third message that indicates the network analytics associated with the respective operation and the respective set of parameters that correspond to the set ID.

An apparatus for wireless communication at a first device is described. The apparatus may include a processor, memory coupled with the processor, and instructions stored in the memory. The instructions may be executable by the processor to cause the apparatus to receive, from a second device, a first message that indicates a set of multiple set IDs associated with network analytics of a core network of a wireless communications system, where each set ID of the set of multiple set IDs corresponds to a respective operation and a respective set of parameters, transmit, to a third device, a second message that indicates a request for network analytics associated with a set ID of the set of multiple set IDs in accordance with the respective operation and the respective set of parameters that correspond to the set ID, and receive, from the third device in response to the request, a third message that indicates the network analytics associated with the respective operation and the respective set of parameters that correspond to the set ID.

Another apparatus for wireless communication at a first device is described. The apparatus may include means for receiving, from a second device, a first message that indicates a set of multiple set IDs associated with network analytics of a core network of a wireless communications system, where each set ID of the set of multiple set IDs corresponds to a respective operation and a respective set of parameters, means for transmitting, to a third device, a second message that indicates a request for network analytics associated with a set ID of the set of multiple set IDs in accordance with the respective operation and the respective set of parameters that correspond to the set ID, and means for receiving, from the third device in response to the request, a third message that indicates the network analytics associated with the respective operation and the respective set of parameters that correspond to the set ID.

A non-transitory computer-readable medium storing code for wireless communication at a first device is described. The code may include instructions executable by a processor to receive, from a second device, a first message that indicates a set of multiple set IDs associated with network analytics of a core network of a wireless communications system, where each set ID of the set of multiple set IDs corresponds to a respective operation and a respective set of parameters, transmit, to a third device, a second message that indicates a request for network analytics associated with a set ID of the set of multiple set IDs in accordance with the respective operation and the respective set of parameters that correspond to the set ID, and receive, from the third device in response to the request, a third message that indicates the network analytics associated with the respective operation and the respective set of parameters that correspond to the set ID.

In some examples of the method, apparatuses, and non-transitory computer-readable medium described herein, receiving the first message may include operations, features, means, or instructions for receiving the first message via first application layer signaling as part of a registration procedure for an application supported at the first device and the second device, where the first message indicates the set of multiple set IDs and the respective operation corresponding to each set ID of the set of multiple set IDs, and where the set of multiple set IDs may be associated with the application.

In some examples of the method, apparatuses, and non-transitory computer-readable medium described herein, transmitting the second message may include operations, features, means, or instructions for transmitting the second message via second application layer signaling, where the second message indicates the set ID such that an application layer of a protocol stack used at the first device may be agnostic to a correspondence between each set ID and the respective set of parameters.

In some examples of the method, apparatuses, and non-transitory computer-readable medium described herein, receiving the first message may include operations, features, means, or instructions for receiving the first message via non-access stratum (NAS) layer signaling, where the first message indicates the set of multiple set IDs and the respective operation corresponding to each set ID of the set of multiple set IDs.

In some examples of the method, apparatuses, and non-transitory computer-readable medium described herein, the first message further indicates a user equipment (UE) policy associated with one or more applications supported at the first device and the second device and each set ID of the set of multiple set IDs may be associated with a respective application of the one or more applications.

In some examples of the method, apparatuses, and non-transitory computer-readable medium described herein, transmitting the second message may include operations, features, means, or instructions for transmitting the second message via application layer signaling, where the second message indicates the respective set of parameters that corresponds to the set ID.

Some examples of the method, apparatuses, and non-transitory computer-readable medium described herein may further include operations, features, means, or instructions for receiving, from a fourth device, a fourth message that indicates the set of multiple set IDs and the respective set of parameters corresponding to each set ID of the set of multiple set IDs, where transmitting the second message that indicates the request and the respective set of parameters may be based on receiving the fourth message.

In some examples of the method, apparatuses, and non-transitory computer-readable medium described herein, receiving the fourth message may include operations, features, means, or instructions for receiving the fourth message via NAS layer signaling, where the fourth message further indicates a UE policy associated with one or more applications supported at the first device and the fourth device, and where each set ID of the set of multiple set IDs may be associated with a respective application of the one or more applications.

Some examples of the method, apparatuses, and non-transitory computer-readable medium described herein may further include operations, features, means, or instructions for transmitting the second message indicating the request for the network analytics is associated with performing the respective operation that corresponds to the set ID.

In some examples of the method, apparatuses, and non-transitory computer-readable medium described herein, the respective operation that corresponds to the set ID may be associated with a machine learning (ML) model used at the first device or the second device, or both.

In some examples of the method, apparatuses, and non-transitory computer-readable medium described herein, the network analytics may be based on the respective set of parameters that corresponds to the set ID.

In some examples of the method, apparatuses, and non-transitory computer-readable medium described herein, the respective set of parameters that corresponds to the set ID may be based on a service level agreement (SLA) associated with the second device.

In some examples of the method, apparatuses, and non-transitory computer-readable medium described herein, the third message includes an indication of statistics or predictions that correspond to the network analytics associated with the respective operation to the first device.

A method for wireless communication at a first device is described. The method may include obtaining, from a second device, a first message that indicates a set of multiple set IDs associated with network analytics of a core network of a wireless communications system, where each set ID of the set of multiple set IDs corresponds to a respective operation and a respective set of parameters, obtaining, from a third device, a second message that indicates a request for network analytics associated with a set ID of the set of multiple set IDs in accordance with the respective operation and the respective set of parameters that correspond to the set ID, and outputting, to the third device in response to the request, a third message that indicates the network analytics associated with the respective operation and the respective set of parameters that correspond to the set ID.

An apparatus for wireless communication at a first device is described. The apparatus may include a processor, memory coupled with the processor, and instructions stored in the memory. The instructions may be executable by the processor to cause the apparatus to obtain, from a second device, a first message that indicates a set of multiple set IDs associated with network analytics of a core network of a wireless communications system, where each set ID of the set of multiple set IDs corresponds to a respective operation and a respective set of parameters, obtain, from a third device, a second message that indicates a request for network analytics associated with a set ID of the set of multiple set IDs in accordance with the respective operation and the respective set of parameters that correspond to the set ID, and outputting, to the third device in response to the request, a third message that indicate the network analytics associated with the respective operation and the respective set of parameters that correspond to the set ID.

Another apparatus for wireless communication at a first device is described. The apparatus may include means for obtaining, from a second device, a first message that indicates a set of multiple set IDs associated with network analytics of a core network of a wireless communications system, where each set ID of the set of multiple set IDs corresponds to a respective operation and a respective set of parameters, means for obtaining, from a third device, a second message that indicates a request for network analytics associated with a set ID of the set of multiple set IDs in accordance with the respective operation and the respective set of parameters that correspond to the set ID, and means for outputting, to the third device in response to the request, a third message that indicates the network analytics associated with the respective operation and the respective set of parameters that correspond to the set ID.

A non-transitory computer-readable medium storing code for wireless communication at a first device is described. The code may include instructions executable by a processor to obtain, from a second device, a first message that indicates a set of multiple set IDs associated with network analytics of a core network of a wireless communications system, where each set ID of the set of multiple set IDs corresponds to a respective operation and a respective set of parameters, obtain, from a third device, a second message that indicates a request for network analytics associated with a set ID of the set of multiple set IDs in accordance with the respective operation and the respective set of parameters that correspond to the set ID, and outputting, to the third device in response to the request, a third message that indicate the network analytics associated with the respective operation and the respective set of parameters that correspond to the set ID.

Some examples of the method, apparatuses, and non-transitory computer-readable medium described herein may further include operations, features, means, or instructions for outputting a fourth message via a network application function (Naf) in response to obtaining the second message that indicates the request for the network analytics, where the fourth message indicates the respective set of parameters and obtaining a fifth message via the Naf in response to outputting the fourth message, where the fifth message indicates the network analytics, and where outputting the third message may be based on receiving the fifth message that indicates the network analytics.

In some examples of the method, apparatuses, and non-transitory computer-readable medium described herein, obtaining the second message may include operations, features, means, or instructions for obtaining the second message via application layer signaling, where the second message indicates the set ID and identifying the respective set of parameters that corresponds to the set ID in response to obtaining the second message, where outputting the fourth message may be based on identifying the respective set of parameters.

In some examples of the method, apparatuses, and non-transitory computer-readable medium described herein, obtaining the second message may include operations, features, means, or instructions for obtaining the second message via application layer signaling, where the second message indicates the respective set of parameters that corresponds to the set ID, and where outputting the fourth message may be based on the second message indicating the respective set of parameters.

In some examples of the method, apparatuses, and non-transitory computer-readable medium described herein, the respective operation that corresponds to the set ID may be associated with a ML model used at the second device or the third device, or both.

Some examples of the method, apparatuses, and non-transitory computer-readable medium described herein may further include operations, features, means, or instructions for obtaining the second message indicating the request for network analytics is associated with the respective operation that corresponds to the set ID.

In some examples of the method, apparatuses, and non-transitory computer-readable medium described herein, the network analytics may be based on the respective set of parameters that corresponds to the set ID.

In some examples of the method, apparatuses, and non-transitory computer-readable medium described herein, the respective set of parameters that corresponds to the set ID may be based on a SLA associated with the second device.

### BRIEF DESCRIPTION OF THE DRAWINGS

FIG. 1 illustrates an example of a wireless communications system that supports techniques for network analytics exposure from a core network of a wireless communications system in accordance with one or more aspects of the present disclosure.

FIG. 2 illustrates an example of a network architecture that supports techniques for network analytics exposure from a core network of a wireless communications system in accordance with one or more aspects of the present disclosure.

FIG. 3 illustrates an example of a wireless communications system that supports techniques for network analytics exposure from a core network of a wireless communications system in accordance with one or more aspects of the present disclosure.

FIGS. 4 and 5 each illustrate an example of a process flow that supports techniques for network analytics exposure from a core network of a wireless communications system in accordance with one or more aspects of the present disclosure.

FIGS. 6 and 7 illustrate block diagrams of devices that support techniques for network analytics exposure from a core network of a wireless communications system in accordance with one or more aspects of the present disclosure.

FIG. 8 illustrates a block diagram of a communications manager that supports techniques for network analytics exposure from a core network of a wireless communications system in accordance with one or more aspects of the present disclosure.

FIG. 9 illustrates a diagram of a system including a device that supports techniques for network analytics exposure from a core network of a wireless communications system in accordance with one or more aspects of the present disclosure.

FIGS. 10 and 11 illustrate block diagrams of devices that support techniques for network analytics exposure from a core network of a wireless communications system in accordance with one or more aspects of the present disclosure.

FIG. 12 illustrates a block diagram of a communications manager that supports techniques for network analytics exposure from a core network of a wireless communications system in accordance with one or more aspects of the present disclosure.

FIG. 13 illustrates a diagram of a system including a device that supports techniques for network analytics exposure from a core network of a wireless communications system in accordance with one or more aspects of the present disclosure.

FIGS. 14 through 17 illustrate flowcharts showing methods that support techniques for network analytics exposure from a core network of a wireless communications system in accordance with one or more aspects of the present disclosure.

### DETAILED DESCRIPTION

Some wireless communications systems may support a client-server architecture in which operations associated with a software application may be partitioned between a provider of services or resources associated with the application and a requestor of the services or resources. The application service provider may be referred to as an application server and the application service requestor may be referred to as an application client. In some examples, the application client may operate at an application layer of a protocol stack at a device, such as a user equipment (UE). That is, a wireless communications system may include one or more communication devices, such as the UE, that support one or more application clients. Operation associated with (e.g., supported by) the application may include artificial intelligence (AI) and machine learning (ML). That is, the application may support AI or ML (AI/ML) operations that may be partitioned (e.g., split) between the application server and the application client at the UE. In some examples, the application client at the UE may perform one or more AI/ML operations to generate or train AI/ML models that may be used at one or more other layers (e.g., lower layers) of the protocol stack at the UE. For example, the application client (e.g., the application layer of the protocol stack, a higher layer) may perform one or more AI/ML operations to generate an AI/ML model that a lower layer of a protocol stack at the UE may use for channel estimation. In some examples, the lower layer may use the AI/ML model generated by the application client (e.g., at the application layer) to measure, predict, or report channel conditions experienced at the UE.

In some examples, the application server and the application client may determine (e.g., coordinate or select) one or more aspects of how and when to partition the AI/ML operations associated with the application. For example, the application server and the application client may determine a first portion of the AI/ML operations to be performed at the application client and a second portion of the AI/ML operations to be performed at the application server. Additionally, the application server and the application client may adjust (e.g., dynamically) the first portion of the AI/ML operations to be performed at the application client and the second portion of the AI/ML operations to be performed at the application server. That is, the application server and the application client may determine respective durations during which the application client may perform the first portion of the AI/ML operations and the application client may perform the second portion of AI/ML operations.

In some examples, processing capabilities associated with the UE (e.g., the local device supporting the application client) may constrain a quantity or type of AI/ML operations that may be performed at the application client. Additionally, while a quantity or type of AI/ML operations that may be performed the application server may be relatively less constrained (e.g., due to increased processing capabilities relative to the UE) increasing the quantity of AI/ML operations performed at the application server 335 may lead to increased latency (e.g., processing delays) for some AI/ML operations.

In some examples, the application client or the application server, or both, may use network analytics associated with a core network of the wireless communications system to improve a performance of one or more AI/ML operations. For example, the application client or the application server, or both, may use the network analytics to determine how and when to partition the AI/ML operations associated with the application. Additionally, in some examples, the application client may obtain (e.g., download) one or more AI/ML models from the application server for AI/ML operations and may use the network analytics to determine when to obtain (or request) the AL/ML model from the application client.

The core network may implement one or more network functions, such as a network data analytics function (NWDAF), which the core network may use to collect information associated with the wireless communications system and generate the network analytics. For example, the core network may use the NWDAF to provide network analytics function services for the wireless communications system. In some examples, the NWDAF may be associated with one or more analytics identifiers (IDs) corresponding to a type of analytics supported at the NWDAF. Accordingly, other network functions or communication devices, such as the UE, may use an analytics ID to obtain network analytics (e.g., of the corresponding type) from the NWDAF. In some examples, however, the UE may be incapable of interpreting analytics IDs. That is, the UE may lack information used to identify a type of analytics that may be associated with a particular analytics ID. Moreover, exposing a correspondence between types of network analytics an analytics IDs may lead to one or more security risks for mobile network operations (MNOs), which may support the NWDAF. Accordingly, the core network may lack a mechanism, much an effective or relatively secure mechanism, for exposing network analytics (e.g., generated at the NWDAF) to the UE via such analytics IDs.

Various aspects of the present disclosure generally relate to techniques for network analytics exposure from a core network of a wireless communications system and, more specifically, to a framework for exposing network analytics to an application client at UE. For example, an application server may configure an application function at the core network, which may be referred to as an information exposure application function (IEAF), with one or more set IDs associated with network analytics that may be obtained from the NWDAF. In such an example, a set ID (e.g., each set ID) may be associated with a respective set of parameter in which a parameter may correspond to a respective type of network analytics that may be obtained from the NWDAF. Additionally, a set ID (e.g., each set ID) may correspond to a respective operation that may performed at the UE and that the UE may use the network analytics for. For example, an operation may include an AI/ML model split operation (e.g., determining how and when to partition AI/ML operations associated with an application) or an AI/ML model download operation (e.g., determine when to download or request to download an AL/ML model from the application server), among other examples.

In some examples, an application layer of the protocol stack at the UE (e.g., an application client at the UE) may be configured with the set IDs and the corresponding operations. Accordingly, the application client may identify a set ID based on an operation performed at the application client and use the set ID to obtain network analytics from the core network (e.g., via the IEAF) while being agnostic to the correspondence between each set ID and the respective sets of parameters. In some other examples, a non-access stratum (NAS) layer of the protocol stack at the UE, which may be more secure relative to the application layer, may be configured with the correspondence between each set ID and the respective sets of parameters. Accordingly, the NAS layer may map a set ID obtained from the application client to the respective set of parameters, which may be used to obtain the network analytics from the core network.

Aspects of the subject matter described herein may be implemented to realize one or more of the following potential advantages. For example, techniques for network analytics exposure from a core network of a wireless communications system, as described herein, may be employed by the described communication devices to provide benefits and enhancements to the operation of the communication devices, including enabling the UE to obtain network analytics from the core network. Further, such techniques may support increased security and increased performance associated with application layer AI/ML operations at the UE, among other possible benefits. Aspects of the disclosure are initially described in the context of wireless communications systems, a network architecture, and process flows. Aspects of the disclosure are further illustrated by and described with reference to apparatus diagrams, system diagrams, and flowcharts that relate to techniques for network analytics exposure from a core network of a wireless communications system.

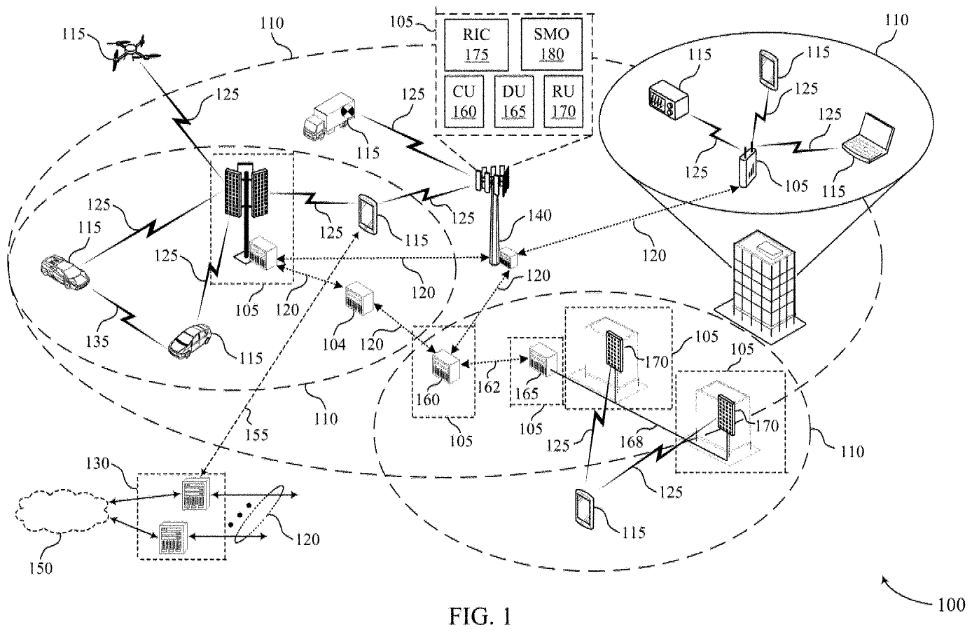

FIG. 1 illustrates an example of a wireless communications system 100 that supports techniques for network analytics exposure from a core network of a wireless communications system in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3 ), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1(L1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for network analytics exposure from a core network of a wireless communications system as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The wireless communications system 100 may support a client-server architecture in which operations associated with an application may be partitioned between an application server and an application client (e.g., a UE 115). The operations associated with the application may include AI/ML operations. The UE 115 or the application server, or both, may use network analytics associated with the core network 130 to determine how and when to partition the AI/ML operations associated with the application. Additionally, the UE 115 may obtain one or more AI/ML models from the application server for AI/ML operations and may use the network analytics to determine when to obtain the AL/ML model. In some examples, the core network 130 may lack a mechanism for exposing network analytics generated at a NWDAF included in the core network 130 to the UE 115.

In some other examples, however, the core network 130 (e.g., and the UE 115) may support a framework for exposing network analytics to an application client at the UE 115. For example, the core network 130 may include an IEAF that may be configured with one or more set IDs associated with network analytics that may be obtained from the NWDAF. A set ID (e.g., each set ID) may be associated with a respective set of parameter and may correspond to a respective operation that may performed at the UE 115. The UE 115 may transmit a request for network analytics associated with a set ID that corresponding to an operation performed at the UE 115 to the IEAF at the core network 130 via application layer signaling. In response to the request, the IEAF may obtain the network analytics from the NWDAF based on the respective set of parameters corresponding to the set ID. The IEAF may forward the network analytics to the UE 115 via application layer signaling. In some examples, using application layer singling to obtain network analytics from the core network 130 may lead to increased performance associated with application layer AI/ML operations at the UE, among other possible benefits.

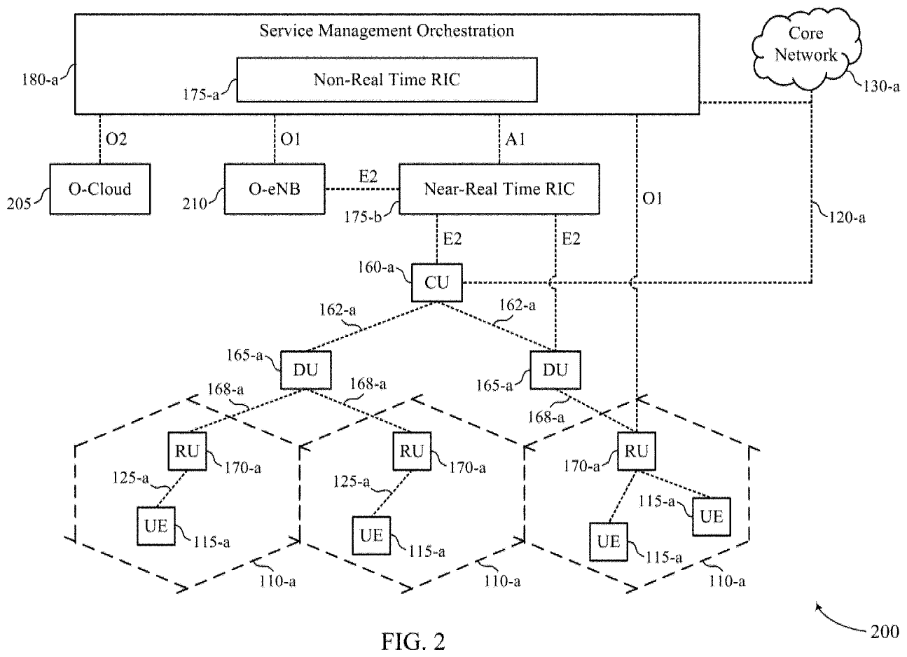

FIG. 2 illustrates an example of a network architecture 200 (e.g., a disaggregated base station architecture, a disaggregated RAN architecture) that supports techniques for network analytics exposure from a core network of a wireless communications system in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an El interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an Ol interface). Additionally, or alternatively, in some implementations, the SMO 180-a may communicate directly with one or more RUs 170-a via an Ol interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, AI/ML workflows including model training and updates, or policy-based guidance of applications/features in the Near-RT RIC 175-b. The Non-RT RIC 175-a may be coupled to or communicate with (e.g., via an Al interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUS 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., Al policies).

In some examples, the core network 130-a may use the Al interface to expose network analytics associated with the core network 130-a to a UE 115. For example, the core network 130-a may include one or more network functions, such as an IEAF and an NWDAF. The core network 130-a may use the NWDAF to generate multiple types of network analytics and the IEAF to expose network analytics generated at the NWDAF to the UE 115 via the Al interface. For example, the UE 115 may include a data exposure client (DEC) and an application client that may communicate via an application programming interface (API). The application client may determine to perform an operation associated with AI/ML model. The operation may be associated with a set ID that corresponds to one or more types of network analytics generated at the NWDAF. For example, the set ID may correspond to a set of parameters, in which each parameter may correspond to a respective type of analytics that may be generated at the NWDAF. The application client may transmit a request for network analytics associated with the set ID to the DEC, which may forward the request to the IEAF at the core network 130-a. The IEAF may use the set of parameters corresponding to the set ID to obtain the associated network analytics from the NWDAF. The IEAF may output the obtained network analytics to the DEC, which may forward the obtained network analytics to the application client. Exposing the network analytics to the UE 115 via the Al interface may enable the core network 130 to reduce security risks associated with exposing network analytics and increase a performance of the operation at the UE 115, among other possible benefits.

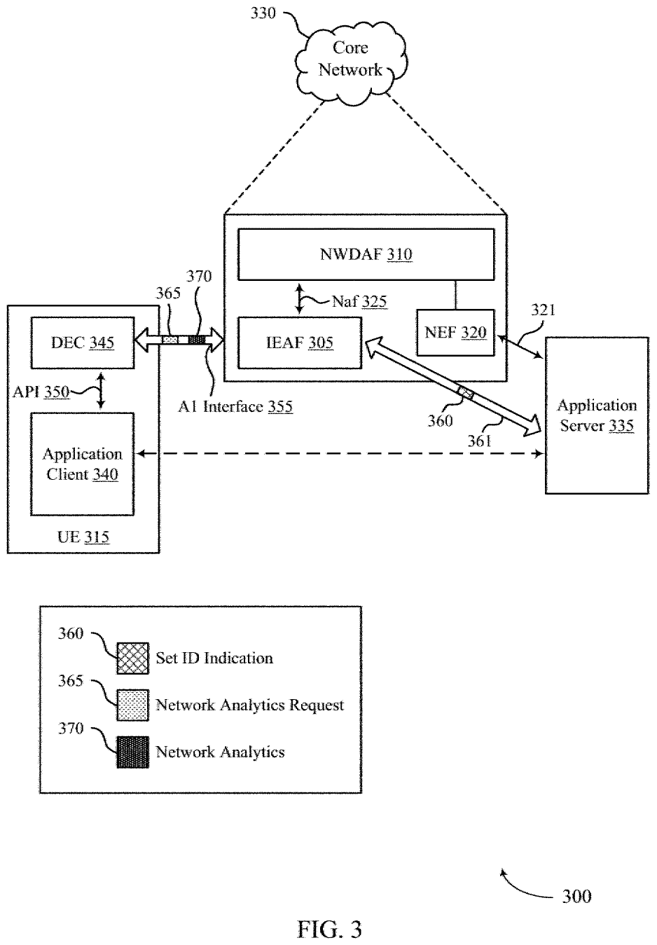

FIG. 3 illustrates an example of a wireless communications system 300 that supports techniques for network analytics exposure from a core network of a wireless communications system in accordance with one or more aspects of the present disclosure. The wireless communications system 300 may implement aspects of the wireless communications system 100 and the network architecture 200. For example, the wireless communications system 300 may include a UE 315, which may be an example of a UE illustrated by and described with reference to FIGS. 1 and 2. The UE 315 may include a DEC 345 and an application client 340, which may be examples of the corresponding entities described with reference to FIGS. 1 and 2. The wireless communications system 300 may also include a core network 330, which may be an example of a core network illustrated by and described with reference to FIGS. 1 and 2. The core network 330 may include one or more core network functions, such as an IEAF 305, a NWDAF 310, and a NEF 320, which may be examples of the corresponding functions described with reference to FIGS. 1 and 2. In some examples, the core network functions may communicate via one or more network application functions (Nafs).

The wireless communications system 300 may support a client-server architecture in which operations associated with a software application may be partitioned between an application service provider (e.g., a provider of services or resources associated with the application), such as an application server 335, and the application client 340 (e.g., a requestor of the services or resources). That is, the UE 315 may support an application associated with the application server 335 and may communicate with the application server 335 using application layer signaling via the application client 340. The application may support AI/ML operations at both the application server 335 and the application client 340. That is, the application may support AI/ML operations that may be partitioned (e.g., split) between the application server 335 and the application client 340 at the UE 315. In other words, an application layer of a protocol stack at the UE 315 (e.g., the application client 340) may perform AI/ML operations in accordance with the associated application and the AI/ML operations may be partitioned between the application server 335 and the application client 340.

In some examples, the application server 335 and the application client 340 may determine (e.g., coordinate) aspects of how and when to split the AI/ML operations. For example, the application may request that both the application server 335 and the application client 340 manage (e.g., handle, perform, coordinate) AL/ML operations associated with the application. Accordingly, the application server 335 and the application client 340 may determine a first portion of the AI/ML operations to be performed at the application client 340 and a second portion of the AI/ML operations to be performed at the application server 335. The first portion and the second portion may include different AI/ML operations or one or more same AI/ML operations. Additionally, the application server 335 and the application client 340 may adjust (e.g., over time, such as dynamically) the first portion of the AI/ML operations to be performed at the application client 340 and the second portion of the AI/ML operations to be performed at the application server. For example, the application server and the application client may determine one or more respective durations during which the application client may perform the first portion (or some other portion) of the AI/ML operations and the application client may perform the second portion (or some other portion) of AI/ML operations.

In some examples, processing capabilities associated with the UE 315 (e.g., a local device supporting the application client 340) may constrain a quantity or type of AI/ML operations that may be performed at the application client 340. Additionally, while a quantity or type of AI/ML operations that may be performed the application server 335 may be relatively less constrained (e.g., due to increased processing capabilities at the application server 335 relative to the UE 315) increasing the quantity of AI/ML operations performed at the application server 335 or allocating relatively more complex types of AI/ML operations to the application server 335 may lead to increased latency (e.g., processing delays) for some AI/ML operations.

In some examples, the application client 340 or the application server 335, or both, may use network analytics associated with the core network 330 of the wireless communications system 300 to improve a performance associated with one or more AI/ML operations associated with the application. For example, the application client 340 (or the application server 335) may use one or more types of network analytics to determine how and when to partition the AI/ML operations associated with the application. That is, to support an application layer AI/ML split function, the application client 340 (or the application server 335) my request that the core network 330 expose network analytics to the UE 315 (e.g., to the application layer of the protocol stack at the UE 315) for determining how and when to partition application layer AI/ML operations between the application client 340 and the application server 335. In other words, to support the application layer AI/ML split function, it may be beneficial for the core network 330 to expose network analytics (e.g., network slice instance load prediction information, service experience prediction information, and user data congestion prediction information) to the application client 340 at the UE 315, such that the application client 340 may use the exposed network analytics to determine how and when to partition (e.g., split) the application layer AI/ML operations between the application client 340 and the application server 335. Additionally, in some examples, the application client 340 may obtain (e.g., download) an AI/ML model from the application server 335 (e.g., the application service provider) for one or more of the AI/ML operations associated with the application. In such examples, the application client 340 may use the exposed network analytics to determine when to download (or to request to download) the AL/ML model from the application client 340. In other words, it may also be beneficial for the application client 340 to consider network analytics (e.g., the network slice instance load prediction information, the service experience prediction information, and the user data congestion prediction information) for determining when to downlink (or to request to download) an AI/ML model from the application server 335.

The core network 330 may use one or more network functions, such as the NWDAF 310, to generate network analytics associated with the wireless communications system 300. For example, the NWDAF 310 may provide network data analytics function services for the wireless communications system 300 (e.g., a 5G system). The network data analytics function services may include an event subscription service (e.g., Nnwdaf_EventsSubscription service) or a network analytics information service (e.g., Nnwdaf_AnalyticsInfo service), among other examples. The NWDAF 310 may collect information (e.g., data, such as statistics, metrics, and events), generate network analytics based on the collected information (e.g., using AI/ML models), and provide the network analytics to the consumers. In other words, the NWDAF 310 may obtain (e.g., collect) information, such as statistics, metrics, and events, and use AI/ML models to generate statistics or predictions (e.g., network analytics) based on the obtained information.

In some examples, the NWDAF 310 may obtain information from UEs (e.g., including the UE 315), applications (e.g., an application server 335), other core network functions, network entities, and operations, administration, and maintenance (OAM) systems, among other examples. In some examples, the NWDAF 310 may obtain information (e.g., data) from the UE 315 and the application server 335 via one or more other functions. For example, the NWDAF 310 may obtain information from (and expose information to) the application server 335 via the NEF 320. Additionally, the NWDAF 310 may obtain information from the UE 315 via a data collection application function (DCAF).

The AMF may be an example of an AMF described with reference to FIG. 1. For example, the AMF may be a control plane entity (e.g., a control plane function) included in the core network 330 that may manage connection and management mobility operations. The AMF may serve as an access point to the core network 330 for communication devices, such as UEs (e.g., the UE 315) and network entities. For example, the AMF may communicate with a network entity, such as a CU illustrated by an described with reference to FIGS. 1 and 2, via a control plane interface (e.g., an N2 interface or a next generation control plane (NG-C) interface). Additionally, the AMF may communicate with the UE 315 via NAS signaling (e.g., via an N1 interface). The NWDAF 310 may provide the network analytics to the consumers (e.g., the other core network functions, the OAM) or store the network analytics using one or more data repositories, or both.

In some examples, the core network 330 may include multiple NWDAFs (e.g., including the NWDAF 310). In such examples, an NWDAF (e.g., each NWDAF), may be associated with one or more analytics IDs. An analytics ID (e.g., each analytics ID) associated with an NWDAF may correspond to a respective types of analytics supported at the NWDAF. For example, the NWDAF 310 may be associated with a first analytics ID that corresponds to a first type of analytics supported by (and that may be obtained from) the NWDAF 310. Accordingly, consumers may request network analytics from the NWDAF 310 (e.g., may discover the NWDAF 310 to obtain network analytics) via the first analytics ID. For example, the consumers may obtain network analytics from the NWDAF 310 via subscriptions or request that may indicate one or more analytics IDs corresponding to one or more types of analytics being requested. In some examples, the NWDAF 310 may enable the consumers to subscribe and unsubscribe from notifications, for example based on a threshold.

Network analytics provided by (e.g., generated at) the NWDAF 310 may include statistics and predictions (e.g., obtained using AI or ML operations). For example, the NWDAF 310 may provide statistics or predictions associated with the wireless communications system 300. In some examples, the wireless communications system 300 may support network slicing. In such examples, the NWDAF 310 may provide analytics (e.g., statistics or predictions) associated with network slice instances, such load level information, among other examples. Additionally, the NWDAF 310 may provide other information associated with network slice instances, such as network slice congestion events notifications. A network slice instance, also referred to as a network slice, may correspond to a virtualized instance of a logical network that may include (e.g., be defined by) a subset of available network resources (e.g., virtual resources, computation resources, networking resources, storage resources) and one or more rules for identifying traffic that may be supported via the subset of resources. In some examples, a subset of resource allocated to a network slice may be based on one or more constraints of applications or services associate with the network slice. For example, the network slice may be allocated the subset of resources to satisfy a service level agreements (SLAs) the applications or services associate with the network slice. An SLA may be an example of a contract (e.g., agreement) between an application service provider and an MNO. In some examples, network analytics generated at and exposed by the NWDAF 310 may satisfy one or more SLAs associated with an MNO that may support the NWDAF 310. For example, to reduce security risks for the MNO, the MNO or the application service provide may configure (e.g., allow) the NWDAF 310 (or one or more other core network functions) to expose one or more types of network analytics to consumers, which may be based on the SLAs. In other words, network analytics (e.g., data) exposed from the core network (e.g., via the NWDAF 310) may be based on one or more SLAs.

In some examples, the core network 330 may identify types of network analytics (e.g., different types of network analytics) using one or more analytics IDs. For example, consumers of network analytics from the NWDAF 310 may to request a type of network analytics (e.g., network analytics data) from the NWDAF 310 using an analytics ID associated with the type of network analytics. In other words, the consumers may request a type of network analytics from the NWDAF 310 according to a value of an analytics ID (e.g., values of an EvendId information element (IE)) indicated via the request. The application client 340 may be incapable of interpreting (e.g., understanding) the analytics IDs. For example, the application layer of the protocol stack at the UE 315 may lack information used to identify a type of analytics that may be associated with a particular analytics ID. As such, the application client 340 may be incapable of interpreting network analytics output from the NWDAF 310 (e.g., output data). In other words, network analytics exposed to the application client 340 may be identified using analytics IDs that may not be understood by the application client 340. The core network 330 may expose analytics ID information to the application client 340 such that the application client 340 may interpret network analytics output from the NWDAF 310, however, exposing analytics ID information to the application client 340 may lead to one or more security risks for the MNO. Accordingly, it may be unclear whether or how the core network 330 may indicate the network analytics (e.g., network supported exposed information) to the application client 340. In other words, the core network 330 may lack a mechanism, much an effective mechanism or a relatively secure mechanism, for exposing network analytics (e.g., network supported analytics information) to the UE 315 application layer (e.g., the application client 340).

In some examples, techniques for network analytics exposure from a core network of a wireless communications system, as described herein, may provide a framework for exposing network analytics to the application client 340 while maintaining (or improving) security for the MNO. As illustrated in the example of FIG. 3, the application server 335 may configure the IEAF 305 with one or more set IDs associated with network analytics from the NWDAF 310. For example, the IEAF 305 may obtain (e.g., via an interface 361) a set ID indication 360 from the application server 335 that may indicate multiple set IDs associated with network analytics that may be obtained from the NWDAF 310. In such an example, a set ID (e.g., each set ID) may be associated with a respective set of parameters and a respective operation. A parameter included in a set of parameters corresponding to a set ID may correspond to a type of network analytics that may be obtained from the NWDAF 310. Additionally, an operation associated with a set ID may correspond to an operation that may performed at the application client 340 (e.g., an operation that the application client 340 may use the obtained network analytics for). For example, an operation may include an AI/ML model split operation (e.g., determining how and when to partition AI/ML operations associated with an application) or an AI/ML model download operation (e.g., determine when to download or request to download an AL/ML model from the application server), among other examples. Accordingly, the set ID indication 360 may, in some examples, indicate multiple sets of parameters corresponding to the multiple set IDs or multiple operations corresponding to the multiple set IDs, or both. In other words, a configuration from the application server 335 to the IEAF 305 (e.g., a data collection application function) may indicate set IDs, respective operations associated with the set IDs, and respective sets of parameters corresponding to the set IDs. In some examples, the configuration (e.g., an SLA configuration) may be based on one or more SLAs. For example, the SLA configuration may indicate (e.g., authorize) one or more types of network analytics (e.g., data) that may be exposed (e.g., shared) with the application client 340. In other words, the multiple sets of parameters corresponding to the multiple set IDs indicated to the IEAF 305 via the set ID indication 360 may correspond to (e.g., indicate, configure) types of network analytics that may be exposed to the application client 340 (e.g., via the IEAF 305). In some examples, the application server 335 may provide the SLA configuration to the IEAF 305 via application layer signaling (e.g., using the interface 361) or via the NEF 320 using an interface 321 (e.g., via control plane signaling within the core network 330).

Associating a set ID with a respective operation performed the application client 340 may enable the IEAF 305 to expose network analytics to the application client 340 without exposing the types of analytics (e.g., the respective set of parameters) associated with the set ID to the application client 340. That is, the application client 340 may identify the set ID based on an operation performed at the application client 340 and use the set ID to obtain network analytics from the core network (e.g., via the IEAF 305) while being agnostic to the correspondence between each set ID and the respective sets of parameters.

To obtain network analytics from the IEAF 305, the application client 340 may use an ID (e.g., address) associated with the IEAF 305. For example, the PCF may indicate an address associated with the IEAF 305 to the DEC 345 (e.g., through the AMF via NAS signaling) and the DEC 345 may indicate the address associated with the IEAF 305 to the application client 340. In some examples, the PCF may provide the IEAF address to the DEC 345 via a UE policy. The UE policy may provide information associated with mapping traffic (e.g., different traffic) to one or more PDU sessions (e.g., different PDU sessions) and one or more network slices. For example, the PCF may provide an IEAF address configuration to the DEC 345 at the UE 315 via the UE policy, which may indicate the IEAF address associated with the IEAF 305. In some examples, the PCF may provide the multiple set IDs configured at the IEAF 305 to the application client 340 via the DEC 345. For example, the PCF may use the UE policy (e.g., indicated via the DEC 345) to provide the application client 340 with the IEAF address, the multiple set IDs, and the multiple operations corresponding to the multiple set IDs. In some other examples, the application client 340 may obtain the multiple set IDs and the multiple operations corresponding to the multiple set IDs via the application server 335. In other words, the application client 340 may receive an indication of multiple set IDs associated with network analytics of the core network 330 from the PCF (e.g., via the DEC 345) or from the application server 335, in which each set ID corresponds to a respective operation and a respective set of parameters.

The application client 340 may establishes a protocol data unit (PDU) session with IEAF 305 (e.g., via the DEC 345), such that the application client 340 may obtain network analytics from the IEAF 305. In other words, as part of a data collection procedure, the DEC 345 may establish a PDU session (e.g., an application layer connection in accordance with an exposed data configuration) with the IEAF 305. In some examples, the PDU session may provide connectivity between the application client 340 and the core network 330. For example, the application client 340 may use the PDU session to obtain the network analytics from the IEAF 305 via the DEC 345. In other words, during a PDU session, the application client 340 may transmit (e.g., via the DEC 345) a network analytics request 365 for network analytics associated with a set ID (e.g., of the multiple set IDs) in accordance with the respective operation and the respective set of parameters that correspond to the set ID. For example, the DEC 345 may transmit the network analytics request 365 (e.g., a data collection request) to the IEAF 305 via application layer signaling (e.g., via an Al interface 355) and the network analytics request 365 may indicate a request for network analytics associated with the set ID. The Al interface 355 may be an example of an Al interface illustrated by and described with reference to FIG. 2. The set ID may be based on an operation performed at the application client 340. For example, the application client 340 may determine to perform an operation associated with the set ID. Accordingly, in some examples, the application client may indicate the set ID associated with the operation to the IEAF 305 via the network analytics request 365 (e.g., through the DEC 345). In some other examples, the core network may configure a NAS layer of a protocol stack at the UE 315 with the multiple sets of parameters associated with the multiple set IDs. In such examples, the network analytics request 365 may indicate the set of parameters corresponding to the set ID.

In some examples, such as in response to obtaining the network analytics request 365, the IEAF 305 may perform NWDAF discovery. For example, the IEAF 305 may use an analytics ID associated with the NWDAF 310 (e.g., and one or more of the parameters corresponding to the set ID) to discover the NWDAF 310 and obtain network analytics from the NWDAF. In some examples, based on discovering the NWDAF 310, the IEAF 305 may use a service operation (e.g., a Nwdaf_AlantricsSubstription_subscribe service operation) to obtain event notifications (e.g., and the requested network analytics) from the NWDAF 310 (e.g., on a particular network slice instance that may be specified via the subscription indication). In some examples, a subscription to the NWDAF 310 may be based on user consent. For example, in response to receiving the subscription indication the NWDAF 310 may perform a user consent check. In some examples, based on the user consent check, the NWDAF 310 may use another service operation (e.g., a Nwdaf AlantricsSubstription Notify service operation) to notify the IEAF 305 about subscribed events (e.g., network analytics 370). In some examples, an event may include a threshold being exceeded (e.g., a load threshold, a congestion threshold). Additionally, or alternatively, an event may correspond to a periodic notification. For example, the NWDAF 310 may be configured to provide the IEAF 305 with (or notify the IEAF 305 about) the network analytics 370 according to a periodicity.

In some examples, the IEAF 305 may use the service operation (or another type of request) to obtain the network analytics requested by the application client 340 from the NWDAF 310. For example, the IEAF 305 may output a message via a Naf 325 that indicates a request for the network analytics (e.g., the network analytics requested by the application client 340). The message may indicate the respective set of parameters associated with the set ID.

In some examples, such as in response to the network analytics request 365, the application client 340 may receive network analytics 370 from the IEAF 305. The network analytics 370 may be associated with the respective operation and the respective set of parameters that correspond to the set ID. For example, the IEAF 305 may indicate (e.g., configure) the network analytics 370 (e.g., allowed exposed data) to the DEC 345, which may forward the network analytics 370 to the application client 340 via an API 350.

The IEAF 305 may obtain the network analytics 370 from the NWDAF 310 (e.g., via the Naf 325) in response to the network analytics request 365. The network analytics 370 may include load level information, such as analytics (e.g., predictions or statistics) associated with a traffic load or resource usage within a network slice instance. Additionally, or alternatively, the network analytics 370 may include analytics associated with a service experience (e.g., NWDAF 310 services) of the application or the UE 315 (e.g., a UE group), load analytics associated with another core network function, network load performance analytics, future load predictions, UE behavior analytics (e.g., predicted behaviors associated with the UE 315, anomalous behavior associated with the UE 315), UE mobility analytics, UE communication analytics (e.g., predictions or statistics associated with wireless communications at the UE 315), network congestion analytics, or quality of service (QOS) analytics, among other examples.

The IEAF 305 may output the network analytics 370 to the DEC 345 via application layer signaling (e.g., via the Al interface 355). In other words, the DEC 345 may send the network analytics request 365 to the IEAF 305, receive the network analytics 370 (e.g., exposed data) from the IEAF 305, and forward the network analytics 370 to the application client 340, which may be the consumer of the network analytics 370 (e.g., the exposed data). In some examples, enabling the application client 340 to obtain network analytics from the core network 330 may lead to increased performance associated with application layer AI/ML operations at the UE 315, among other possible benefits.

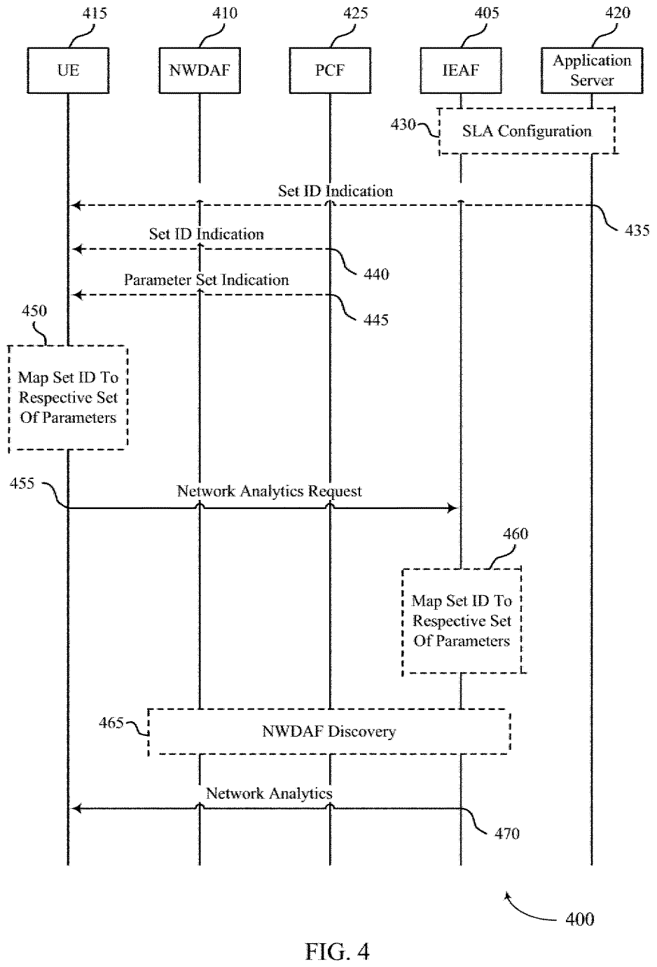

FIG. 4 illustrates an example of a process flow 400 that supports techniques for network analytics exposure from a core network of a wireless communications system in accordance with one or more aspects of the present disclosure. The process flow 400 may implement or be implemented at one or more aspects of the wireless communications system 100, the network architecture 200, and the wireless communications system 300. For example, the process flow 400 may be implemented at a UE 415, a NWDAF 410, a PCF 425, an IEAF 405, and an application server 420, which may be examples of the corresponding devices illustrated by and described with reference to FIGS. 1 through 3. The operations performed at the UE 415, the NWDAF 410, the PCF 425, the IEAF 405, and the application server 420 may support improvements to network analytics exposure from a core network of a wireless communications system, among other benefits. In the following description of the process flow 400, the operations performed at the UE 415, the NWDAF 410, the PCF 425, the IEAF 405, and the application server 420 may occur in a different order than the example order shown. Additionally, the operations performed at the UE 415, the NWDAF 410, the PCF 425, the IEAF 405, and the application server 420 may be performed at different times. Some operations may be combined and some operations may be omitted. In some examples, the UE 415, the NWDAF 410, the PCF 425, the IEAF 405, and the application server 420 may support a framework for exposing network analytics to an application layer of a protocol stack at the UE 415.

The IEAF 405 may be configured with information for obtaining network analytics associated with the wireless communications system from the IEAF 405. The information may include multiple set IDs, a respective operation corresponding to each set ID, and a respective set of parameters associated with each set ID. In some examples, the information may be configured (e.g., pre-configured) at the IEAF 405 via an MNO that supports the IEAF 405 or provisioned to the IEAF 405, for example via the application server 420 (e.g., via an application service provider).

For example, at 430, the application server 420 may perform an SLA configuration with the IEAF 405. The SLA configuration may include the application server 420 indicating the multiple set IDs associated with network analytics that may be obtained from the NWDAF 410 and the corresponding sets of parameters to the IEAF 405. Each set ID of the multiple set IDs indicated to the IEAF 405 (e.g., configured at the IEAF 405 as part of the SLA configuration at 430) may correspond to a respective operation (e.g., AI/ML operation) and a respective set of parameters. In some examples, the SLA configuration at 430 may be based on an SLA between the application service provider (e.g., the application server 420) and the MNO that may support the IEAF 405 and the NWDAF 410. For example, the application service provider may negotiate with the MNO regarding the sets of parameters (e.g., and corresponding analytics) that may be exposed to the UE 415 for the multiple operations (e.g., for different purposes). That is, the application server 420 may use the SLA configuration at 430 to configure the IEAF 405 with multiple sets of parameters (e.g., and a respective set ID associated with each set of parameters) that correspond to multiple types of network analytics that the IEAF 405 may expose to the UE 415 for multiple (e.g., different) operations.

As an illustrative example, the SLA configuration at 430 may include the application server 420 indicating a first set ID (e.g., set ID 1), a second set ID (e.g., set ID 2), a first set of parameters corresponding to the first set ID, a second set of parameters corresponding to the second set ID, a first operation associated with the first set ID, and a second operation associated with the second set ID. In such an example, the operation associated with the first set ID may include an AI/ML model download operation. That is, the first set ID may be used at (e.g., may defined for) an application client at the UE 415 to obtain network analytics that the application client may use to improve AI/ML model downloads. In other words, the application client at the UE 415 may use network analytics associated with the first set ID to determine when to download an AI/ML model from the application server 420. Accordingly, in some examples, the first set of parameters corresponding to the first set ID may include a parameter associated with service experience prediction analytics, a parameter associated with QoS monitoring analytics, and a parameter associated with UE mobility prediction analytics, among other examples. The operation associated with the second set ID may include an AI/ML model split operation. That is, the second ID may be used at the application client at the UE 415 to obtain network analytics that the application client may use to improve partitioning (e.g., a split) of AI/ML model operations between the application client at the UE 415 and the application server 420. In other words, the application client at the UE 415 may use network analytics associated with the second set ID to determine when and how to split AI/ML model operations between the application client at the UE 415 and the application server 420. Accordingly, in some examples, the second set of parameters may include a parameter associated with QoS sustainability prediction analytics, a parameter associated with slice load prediction analytics, and a parameter associated with data network performance prediction analytics, among other examples.

To request network analytics from the IEAF 405, the application layer of the protocol stack at the UE 415 (e.g., the application client at the UE 415) may be configured with the multiple set IDs and the multiple operations corresponding to the multiple set IDs. For example, the application client at the UE 415 may receive a set ID indication that indicates at least the multiple set IDs (e.g., one or more of the set IDs configured at the IEAF 405) and a respective operation corresponding to each set ID.

In some examples, at 435, the UE 415 may receive the set ID indication from the application server 420 via application layer signaling. For example, the UE 415 may receive an indication of the multiple set IDs via application layer signaling that the UE 415 may use to obtain network analytics (e.g., one or more types of network analytics) from the IEAF 405. In some examples, the UE 415 may receive the indication via a configuration between the application server 420 and the application client at the UE 415. For example, the UE 415 (e.g., the application client at the UE 415) may receive the set ID indication during an application layer registration (e.g., of an application associated with the application client at the UE 415 and the application server 420). In such an example, the multiple set IDs may correspond to the application being registered. Additionally, the application server 420 may transmit (e.g., send) the multiple set IDs and the respective operation (e.g., purpose) for each set ID to the application client at the UE 415 (e.g., a UE application client). For example, the application server 420 may indicate, to the application client at the UE 415, the first set ID (e.g., set ID 1), which may be used for the AIML ML model download operation, and the second set ID (e.g., set ID 2), which may be used for the AI/ML model split operation.

In some other examples, at 440, the UE 415 may receive the set ID indication from the PCF 425 via NAS signaling (e.g., through an AMF). For example, the UE 415 may receive the indication of the multiple set IDs that the UE 415 may use to obtain network analytics (e.g., one or more types of network analytics) from the IEAF 405 via another configuration between the PCF 425 and the UE 415. In some examples, the PCF 425 may provide the set ID indication to the UE 415 via a UE policy. In such examples, the set ID indication may include set IDs for multiple application IDs (e.g., each application ID) included in the UE policy. The UE policy (e.g., including the set ID indication) may be sent to the UE 415 during a registration area update procedure (e.g., with the PCF 425).

At 455, the UE 415 may transmit a network analytics request to the IEAF 405 for network analytics associated with a set ID of the multiple set IDs in accordance with the respective operation and the respective set of parameters that correspond to the set ID. In some examples, the UE 415 may transmit the network analytics request to the IEAF 405 via application layer signaling. In other words, the application client at the UE 415 (e.g., via a DEC at the UE 415) may transmit the network analytics request to the IEAF 405 to obtain network analytics associated with the set ID in connection with performing the respective operation that corresponds to the set ID.

In some examples, the application client at the UE 415 may be unaware of the corresponding parameters for each set ID. That is, the application client at the UE 415 may be agnostic to a correspondence between each set ID and the respective set of parameters. In such an example, the network analytics request transmitted at 455 may indicate the set ID. For example, the application client at the UE 415 may send the network analytics request (e.g., a data request) that indicates the set ID to the IEAF 405 to request network analytics (e.g., parameters) for the respective operation (e.g., purpose). For example, the network analytics request may indicate the first set ID to request network analytics for the AI/ML model download operation or the second set ID to request network analytics for the AI/ML model split operation. In other words, the UE 415 receives the multiple set IDs via the set ID indication from the PCF 425 (e.g., in the UE Policy, which may be transmitted at 440) or from the application server 420 (e.g., during application registration, which may occur at 435) and the sends a set ID of the multiple set IDs to the IEAF 405 in the network analytics request (e.g., a data collection request) at 455 to request network analytics associated with the set ID.

In such examples, at 460, the IEAF 405 may map the set ID indicated via the network analytics request to the respective set of parameters. In some examples, the IEAF 405 may map the set ID to the respective set of parameters based on the SLA configuration at 430. For example, the set ID may include the first set ID (e.g., set ID 1), which the IEAF 405 may map to the set of parameters that correspond to the service experience prediction analytics, the QoS monitoring analytics, and the UE mobility prediction analytics. Alternatively, the set ID may include the second set ID (e.g., set ID 2), which the IEAF 405 may map to the set of parameters that correspond to the QoS sustainability prediction analytics, the slice load prediction analytics, and the data network performance prediction analytics. In some examples, the IEAF 405 may send the respective set of parameters to NWDAF 410 to obtain the corresponding analytics.

In some other examples, a NAS layer of the protocol stack used at the UE 415 may be aware of the corresponding parameters for each set ID. For example, at 445, the UE 415 may receive a parameter set indication from the PCF 425 via NAS layer signaling. That is, the NAS layer of the protocol stack at the UE 415 may receive the parameter set indication from the PCF 425 via a configuration between the PCF 425 and the UE 415. The parameter set indication may include the multiple set IDs, the respective operation corresponding to each set ID, and the respective set of parameters corresponding to each set ID. In some examples, the multiple set IDs may correspond to multiple applications. For example, the UE policy may indicate multiple application IDs associated with multiple (e.g., different applications). In such an example, the PCF 425 may include (e.g., in the parameter set indication) the set IDs for each application ID in UE policy (e.g., sent to the UE 415 via NAS signaling during the registration area update procedure).

In some examples, at 450, the NAS layer of the protocol stack at the UE 415 may map the set ID to the respective set of parameters. For example, the application layer of the protocol stack at the UE 415 (e.g., the application client at the UE 415) may provide the set ID to the NAS layer of the protocol stack at the UE 415 to request the set of parameters corresponding to the set ID. That is, the NAS layer of the protocol stack at the UE 415 may obtain an indication of the set ID (e.g., corresponding to the operation performed at the UE 415) from the application client at the UE 415, such that the UE 415 may include the set of parameters in the network analytics request transmitted from the UE 415 at 455. In other words, the application client at the UE 415 provides the set ID to the NAS layer at the UE 415 (e.g., to request the corresponding set of parameters). In response, the NAS layer at the UE 415 maps the set of parameters corresponding to the set ID based on the UE policy (e.g., provided to by the PCF 425) and sends the requested parameters to the IEAF 405 in the network analytics request (e.g., a data collection request).

In some examples, at 465, the IEAF 405 may perform NWDAF discovery. For example, in response to obtaining the network analytics request at 455, the IEAF 405 may perform NWDAF discovery to obtain the network analytics corresponding to the set of parameters, which may have been indicated to the IEAF 405 via the network analytics request or determined at the IEAF 405 based on the IEAF mapping the set ID indicated via the network analytics request to the respective set of parameters (e.g., at 460).

At 470, the UE 415 may receive the network analytics via application layer signaling from the IEAF 405 in response to the network analytics request. The network analytics may be associated with the respective operation and the respective set of parameters that correspond to the set ID. In some examples, using the IEAF 405 to expose network analytics to the UE 415 may lead to increased security and increased performance associated with application layer AI/ML operations at the UE 415, among other possible benefits.

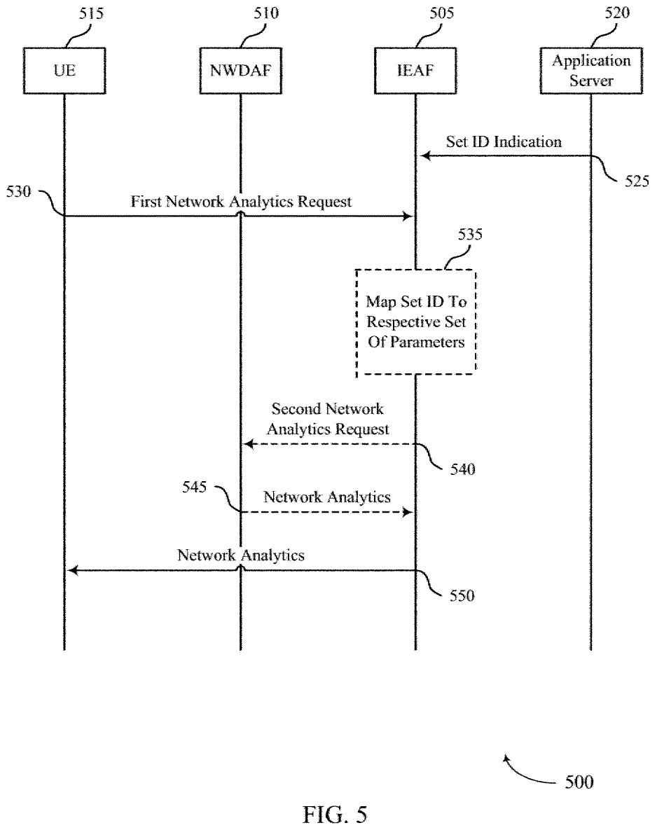

FIG. 5 illustrates an example of a process flow 500 that supports techniques for network analytics exposure from a core network of a wireless communications system in accordance with one or more aspects of the present disclosure. The process flow 500 may implement or be implemented at one or more aspects of the wireless communications system 100, the network architecture 200, the wireless communications system 300, and the process flow 400. For example, the process flow 500 may be implemented at a UE 515, a NWDAF 510, an IEAF 505, and an application server 520, which may be examples of the corresponding devices illustrated by and described with reference to FIGS. 1 through 4. The operations performed at the UE 515, the NWDAF 510, the IEAF 505, and the application server 520 may support improvements to network analytics exposure from a core network of a wireless communications system, among other benefits. In the following description of the process flow 500, the operations performed at the UE 515, the NWDAF 510, the IEAF 505, and the application server 520 may occur in a different order than the example order shown. Additionally, the operations performed at the UE 515, the NWDAF 510, the IEAF 505, and the application server 520 may be performed at different times. Some operations may be combined and some operations may be omitted. In some examples, the UE 515, the NWDAF 510, the IEAF 505, and the application server 520 may support a framework for exposing network analytics to an application layer of a protocol stack at the UE 515.

At 525, the IEAF 505 may obtain a set ID indication from the application server 520. The set ID indication may indicate multiple set IDs associated with network analytics obtained from the NWDAF 510 (e.g., included in the core network of a wireless communications system). In some examples, each set ID of the multiple set IDs may correspond to a respective operation and a respective set of parameters. For example, the IEAF 505 may receive the set ID indication from the application server 520 via an SLA configuration between the application server 520 and the IEAF 505. In some examples, the SLA configuration may be based on a SLA. That is, an application service provider associated with the application server 520 may negotiate with an MNO that supports the IEAF 505 and the NWDAF 510 regarding sets of parameters that may correspond to the set IDs (e.g., and may be exposed from the core network for different purposes). For example, the SLA configuration may indicate each set of parameters corresponding to each set ID. As an illustrative example, the SLA configuration may indicate that a first set ID (e.g., set ID 1), which may be used at the UE 515 for (e.g., may be defined for) an AI/ML model download operation. The first set ID may correspond to a set of parameters that includes a parameter associated with service experience prediction analytics, a parameter associated with QoS monitoring analytics, and a parameter associated with UE mobility prediction analytics, among other examples. Additionally, the SLA configuration may indicate that a second set ID (e.g., set ID 2), which may be used at the UE 515 for (e.g., may be defined for) an AI/ML model split operation. The second set ID may correspond to a set of parameters that includes a parameter associated with QoS sustainability prediction analytics, a parameter associated with slice load prediction analytics, and a parameter associated with data network performance prediction analytics.

At 530, the IEAF 505 may obtain a first network analytics request via application layer signaling from the UE 515 (e.g., from an application client at the UE 515) for network analytics associated with a set ID of the multiple set IDs indicated to the IEAF 505 via the set ID indication (e.g., received at 525). In some examples, the first network analytics request may indicate the set ID to request network analytics in accordance with a respective operation. For example, the set ID included in the first network analytics request may be in accordance with the respective operation and a respective set of parameters that correspond to the set ID. For example, the application client at the UE 515 may transmit (e.g., via a DEC at the UE 515) the first network analytics request to the IEAF 505 to obtain network analytics associated with the set ID in connection with performing the respective operation that corresponds to the set ID. In other words, the UE 515 may send the first network analytics request (e.g., a data request) to the IEAF 505 to request analytics for an operation (e.g., a particular operation), such as the AI/ML model download operation or the AI/ML model split operation. Accordingly, the first network analytics request may indicate the corresponding set ID. In such an example, the IEAF 505 may use the set ID to identify the respective set of parameters (e.g., for obtaining the network analytics from the NWDAF 510).

For example, at 535, the IEAF 505 may map the set ID to the respective set of parameters. That is, based on receiving the set ID at the IEAF 505 via the first network analytics request (e.g., in a data collection request) from the UE 515, the IEAF 505 may map the corresponding parameters to the received set ID. In other words, the IEAF 505 may identify the respective set of parameters that corresponds to the set ID in response to obtaining the first network analytics request (e.g., that indicates the set ID). In some examples, the IEAF 505 may map the set ID to the parameters based on the SLA configuration. For example, the IEAF 505 may map the first set ID (e.g., set ID 1) to the parameters associated with the service experience prediction analytics, the QoS monitoring analytics, and the UE mobility prediction analytics. Additionally, the IEAF 505 may map the second set ID (e.g., set ID 2) to the parameters associated with the QOS sustainability prediction analytics, the slice load prediction analytics, and the data network performance prediction analytics.

In some other examples, the first network analytics request may indicate the respective set of parameters correspond to the set ID to request network analytics in accordance with the respective operation. For example, the first network analytics request message may indicate a first set of parameters corresponding to the first set ID to requests analytics associated with the AI/ML model download operation and a second set of parameters corresponding to the second ID to request analytics associated with the AI/ML model split operation.

In some examples, at 540, the IEAF 505 may output a second network analytics request to the NWDAF 510 (e.g., via an Naf). The second network analytics request may indicate a request for the network analytics from the NWDAF 510. For example, the second network analytics request may indicate the set of parameters that correspond to the set ID to request the corresponding analytics. That is, the IEAF 505 may send the parameters corresponding to the se ID to NWDAF 510.

In some examples, at 545, the IEAF 505 may obtain an indication of the network analytics from the NWDAF 510 (e.g., via the Naf). For example, the IEAF 505 may obtain the indication of the network analytics from the NWDAF 510 in response to the second network analytics request. In some examples, the second network analytics request and the indication of the network analytics (e.g., obtained in response to the second network analytics request) may be communicated between the IEAF 505 and the NWDAF 510 in accordance with an NWDAF discovery procedure.

At 550, the IEAF 505 may output an indication of the network analytics associated with the respective operation and the respective set of parameters that correspond to the set ID to the UE 515. For example, the IEAF 505 may output the network analytics in response to the first network analytics request. In some examples, the IEAF 505 may output the indication of the network analytics to the UE 515 via application layer signaling. That is, the IEAF 505 may output an indication of the network analytics to the application client at the UE 515 (e.g., via the DEC at the UE 515). In some examples, outputting the network analytics to the UE 515 via application layer signaling may lead to increased performance associated with application layer AI/ML operations at the UE 515, among other possible benefits.

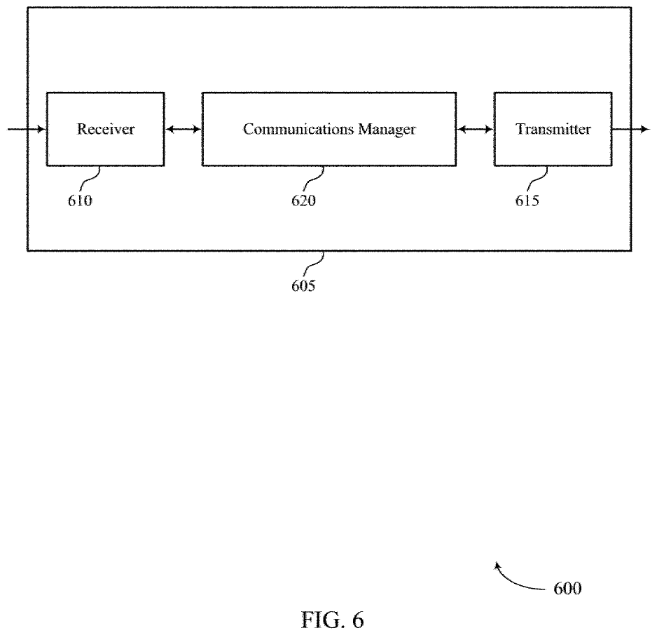

FIG. 6 illustrates a block diagram 600 of a device 605 that supports techniques for network analytics exposure from a core network of a wireless communications system in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for network analytics exposure from a core network of a wireless communications system). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for network analytics exposure from a core network of a wireless communications system). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for network analytics exposure from a core network of a wireless communications system as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a first device (e.g., the device 605) in accordance with examples as disclosed herein. For example, the communications manager 620 may be configured as or otherwise support a means for receiving, from a second device, a first message that indicates a set of multiple set IDs associated with network analytics of a core network of a wireless communications system, where each set ID of the set of multiple set IDs corresponds to a respective operation and a respective set of parameters. The communications manager 620 may be configured as or otherwise support a means for transmitting, to a third device, a second message that indicates a request for network analytics associated with a set ID of the set of multiple set IDs in accordance with the respective operation and the respective set of parameters that correspond to the set ID. The communications manager 620 may be configured as or otherwise support a means for receiving, from the third device in response to the request, a third message that indicates the network analytics associated with the respective operation and the respective set of parameters that correspond to the set ID.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing and more efficient utilization of communication resources.

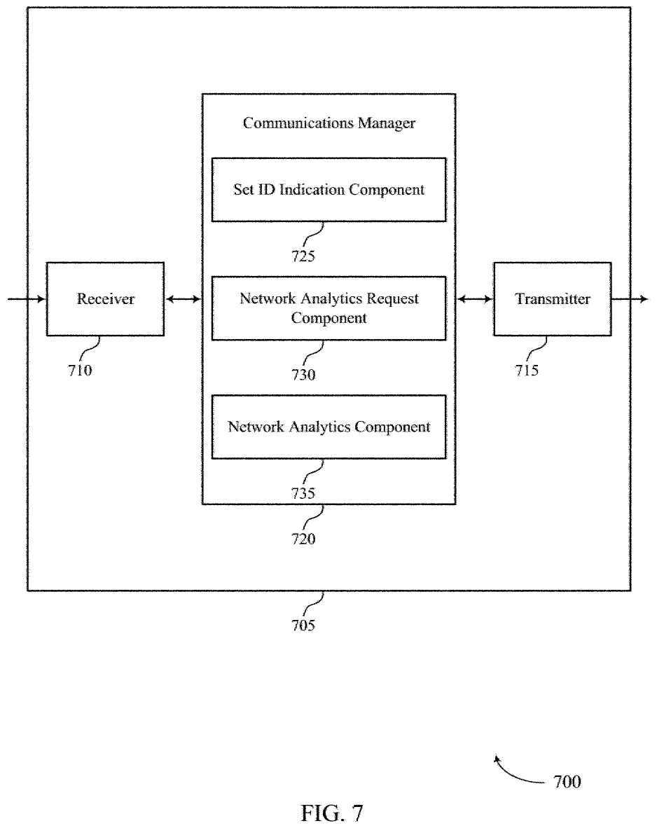

FIG. 7 illustrates a block diagram 700 of a device 705 that supports techniques for network analytics exposure from a core network of a wireless communications system in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for network analytics exposure from a core network of a wireless communications system). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for network analytics exposure from a core network of a wireless communications system). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for network analytics exposure from a core network of a wireless communications system as described herein. For example, the communications manager 720 may include a set ID indication component 725, a network analytics request component 730, a network analytics component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first device (e.g., the device 705) in accordance with examples as disclosed herein. The set ID indication component 725 may be configured as or otherwise support a means for receiving, from a second device, a first message that indicates a set of multiple set IDs associated with network analytics of a core network of a wireless communications system, where each set ID of the set of multiple set IDs corresponds to a respective operation and a respective set of parameters. The network analytics request component 730 may be configured as or otherwise support a means for transmitting, to a third device, a second message that indicates a request for network analytics associated with a set ID of the set of multiple set IDs in accordance with the respective operation and the respective set of parameters that correspond to the set ID. The network analytics component 735 may be configured as or otherwise support a means for receiving, from the third device in response to the request, a third message that indicates the network analytics associated with the respective operation and the respective set of parameters that correspond to the set ID.

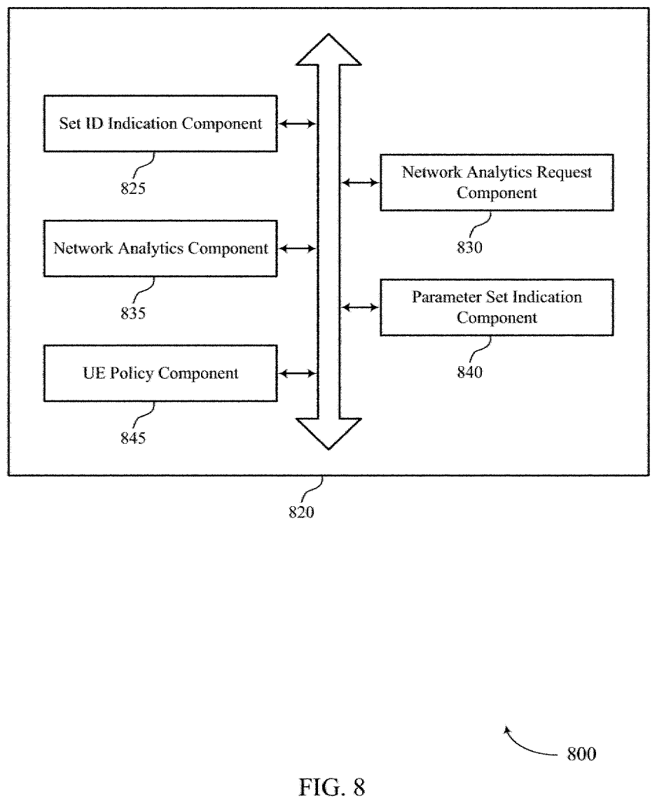

FIG. 8 illustrates a block diagram 800 of a communications manager 820 that supports techniques for network analytics exposure from a core network of a wireless communications system in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for network analytics exposure from a core network of a wireless communications system as described herein. For example, the communications manager 820 may include a set ID indication component 825, a network analytics request component 830, a network analytics component 835, a parameter set indication component 840, a UE policy component 845, or any combination thereof. Each of these components may communicate, directly or indirectly, with one another (e.g., via one or more buses).

The communications manager 820 may support wireless communication at a first device in accordance with examples as disclosed herein. The set ID indication component 825 may be configured as or otherwise support a means for receiving, from a second device, a first message that indicates a set of multiple set IDs associated with network analytics of a core network of a wireless communications system, where each set ID of the set of multiple set IDs corresponds to a respective operation and a respective set of parameters. The network analytics request component 830 may be configured as or otherwise support a means for transmitting, to a third device, a second message that indicates a request for network analytics associated with a set ID of the set of multiple set IDs in accordance with the respective operation and the respective set of parameters that correspond to the set ID. The network analytics component 835 may be configured as or otherwise support a means for receiving, from the third device in response to the request, a third message that indicates the network analytics associated with the respective operation and the respective set of parameters that correspond to the set ID.

In some examples, to support receiving the first message, the set ID indication component 825 may be configured as or otherwise support a means for receiving the first message via first application layer signaling as part of a registration procedure for an application supported at the first device and the second device, where the first message indicates the set of multiple set IDs and the respective operation corresponding to each set ID of the set of multiple set IDs, and where the set of multiple set IDs are associated with the application.

In some examples, to support transmitting the second message, the network analytics request component 830 may be configured as or otherwise support a means for transmitting the second message via second application layer signaling, where the second message indicates the set ID such that an application layer of a protocol stack used at the first device is agnostic to a correspondence between each set ID and the respective set of parameters.

In some examples, to support receiving the first message, the set ID indication component 825 may be configured as or otherwise support a means for receiving the first message via NAS layer signaling, where the first message indicates the set of multiple set IDs and the respective operation corresponding to each set ID of the set of multiple set IDs. In some examples, the first message further indicates a UE policy associated with one or more applications supported at the first device and the second device. In some examples, each set ID of the set of multiple set IDs is associated with a respective application of the one or more applications.

In some examples, to support transmitting the second message, the parameter set indication component 840 may be configured as or otherwise support a means for transmitting the second message via application layer signaling, where the second message indicates the respective set of parameters that corresponds to the set ID.

In some examples, the set ID indication component 825 may be configured as or otherwise support a means for receiving, from a fourth device, a fourth message that indicates the set of multiple set IDs and the respective set of parameters corresponding to each set ID of the set of multiple set IDs, where transmitting the second message that indicates the request and the respective set of parameters is based on receiving the fourth message.

In some examples, to support receiving the fourth message, the UE policy component 845 may be configured as or otherwise support a means for receiving the fourth message via NAS layer signaling, where the fourth message further indicates a UE policy associated with one or more applications supported at the first device and the fourth device, and where each set ID of the set of multiple set IDs is associated with a respective application of the one or more applications.

In some examples, transmitting the second message indicating the request for the network analytics is associated with performing the respective operation that corresponds to the set ID. In some examples, the respective operation that corresponds to the set ID is associated with an ML model used at the first device or the second device, or both.

In some examples, the network analytics are based on the respective set of parameters that corresponds to the set ID. In some examples, the respective set of parameters that corresponds to the set ID is based on an SLA associated with the second device.

In some examples, the third message includes an indication of statistics or predictions that correspond to the network analytics associated with the respective operation to the first device.

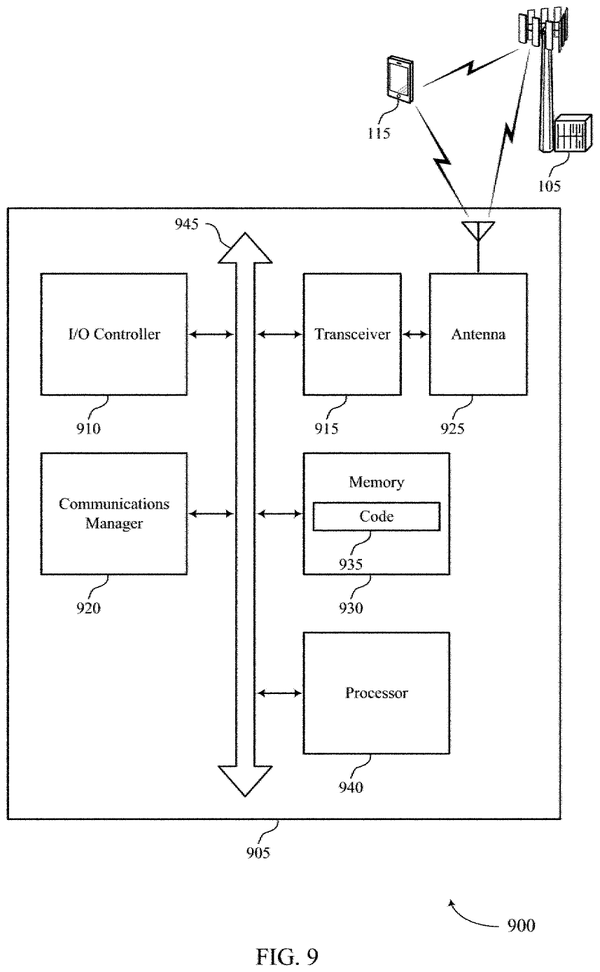

FIG. 9 illustrates a diagram of a system 900 including a device 905 that supports techniques for network analytics exposure from a core network of a wireless communications system in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for network analytics exposure from a core network of a wireless communications system). For example, the device 905 or a component of the device 905 may include a processor 940 and memory 930 coupled with or to the processor 940, the processor 940 and memory 930 configured to perform various functions described herein.

The communications manager 920 may support wireless communication at a first device in accordance with examples as disclosed herein. For example, the communications manager 920 may be configured as or otherwise support a means for receiving, from a second device, a first message that indicates a set of multiple set IDs associated with network analytics of a core network of a wireless communications system, where each set ID of the set of multiple set IDs corresponds to a respective operation and a respective set of parameters. The communications manager 920 may be configured as or otherwise support a means for transmitting, to a third device, a second message that indicates a request for network analytics associated with a set ID of the set of multiple set IDs in accordance with the respective operation and the respective set of parameters that correspond to the set ID. The communications manager 920 may be configured as or otherwise support a means for receiving, from the third device in response to the request, a third message that indicates the network analytics associated with the respective operation and the respective set of parameters that correspond to the set ID.

By including or configuring the communications manager 920 in accordance with examples as described herein, the device 905 may support techniques for improved communication reliability, reduced latency, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of techniques for network analytics exposure from a core network of a wireless communications system as described herein, or the processor 940 and the memory 930 may be otherwise configured to perform or support such operations.

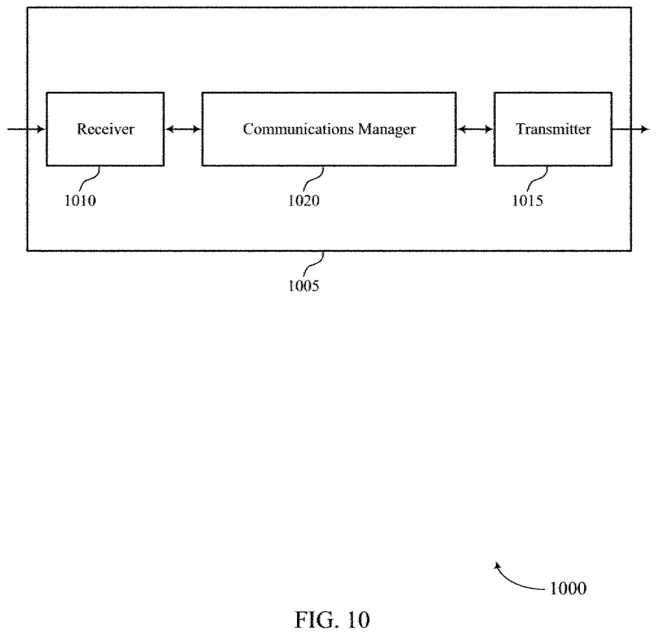

FIG. 10 illustrates a block diagram 1000 of a device 1005 that supports techniques for network analytics exposure from a core network of a wireless communications system in accordance with one or more aspects of the present disclosure. The device 1005 may be an example of aspects of a network entity 105 or a core network 130 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of techniques for network analytics exposure from a core network of a wireless communications system as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a first device (e.g., the device 1005) in accordance with examples as disclosed herein. For example, the communications manager 1020 may be configured as or otherwise support a means for obtaining, from a second device, a first message that indicates a set of multiple set IDs associated with network analytics of a core network of a wireless communications system, where each set ID of the set of multiple set IDs corresponds to a respective operation and a respective set of parameters. The communications manager 1020 may be configured as or otherwise support a means for obtaining, from a third device, a second message that indicates a request for network analytics associated with a set ID of the set of multiple set IDs in accordance with the respective operation and the respective set of parameters that correspond to the set ID. The communications manager 1020 may be configured as or otherwise support a means for outputting, to the third device in response to the request, a third message that indicating the network analytics associated with the respective operation and the respective set of parameters that correspond to the set ID.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing and more efficient utilization of communication resources.

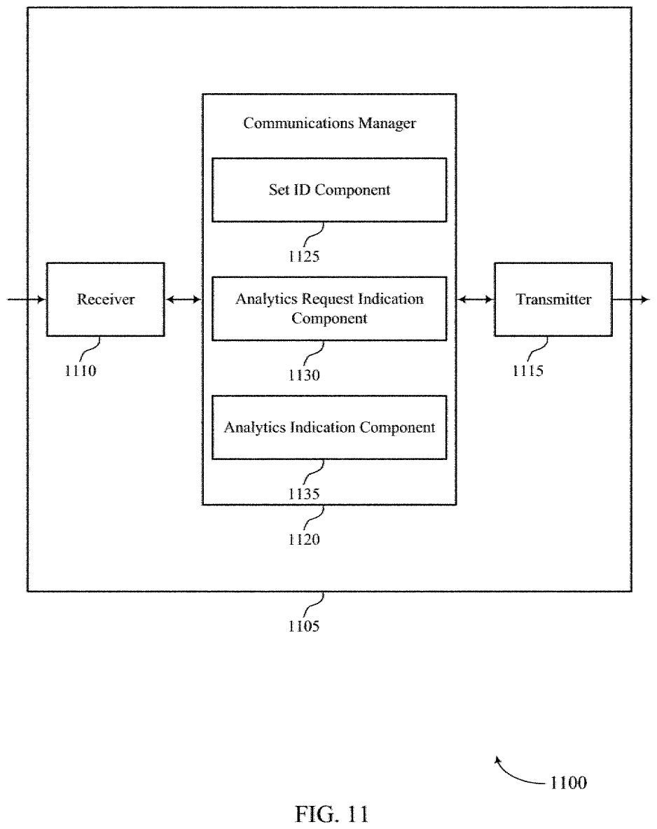

FIG. 11 illustrates a block diagram 1100 of a device 1105 that supports techniques for network analytics exposure from a core network of a wireless communications system in accordance with one or more aspects of the present disclosure. The device 1105 may be an example of aspects of a device 1005 or a network entity 105 or a core network 130 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for network analytics exposure from a core network of a wireless communications system as described herein. For example, the communications manager 1120 may include a set ID component 1125, an analytics request indication component 1130, an analytics indication component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a first device (e.g., the device 1105) in accordance with examples as disclosed herein. The set ID component 1125 may be configured as or otherwise support a means for obtaining, from a second device, a first message that indicates a set of multiple set IDs associated with network analytics of a core network of a wireless communications system, where each set ID of the set of multiple set IDs corresponds to a respective operation and a respective set of parameters. The analytics request indication component 1130 may be configured as or otherwise support a means for obtaining, from a third device, a second message that indicates a request for network analytics associated with a set ID of the set of multiple set IDs in accordance with the respective operation and the respective set of parameters that correspond to the set ID. The analytics indication component 1135 may be configured as or otherwise support a means for outputting, to the third device in response to the request, a third message that indicates the network analytics associated with the respective operation and the respective set of parameters that correspond to the set ID.

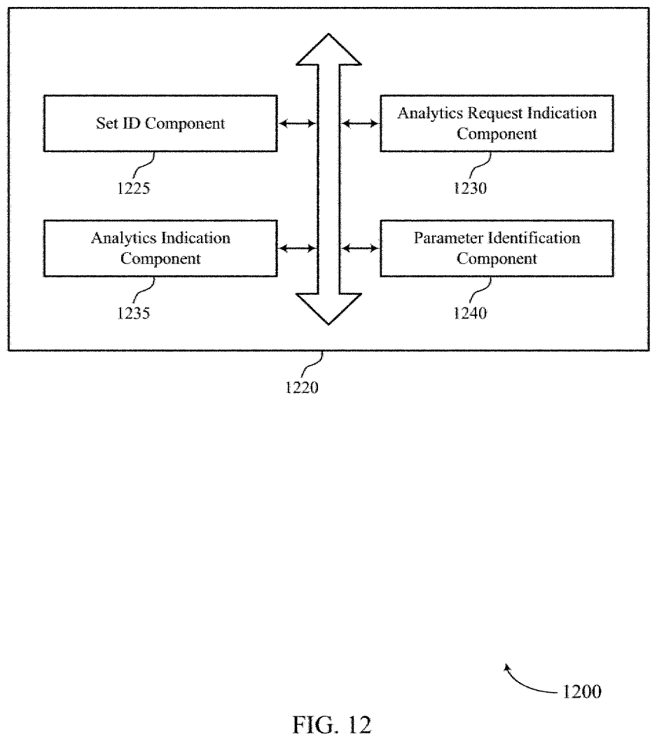

FIG. 12 illustrates a block diagram 1200 of a communications manager 1220 that supports techniques for network analytics exposure from a core network of a wireless communications system in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for network analytics exposure from a core network of a wireless communications system as described herein. For example, the communications manager 1220 may include a set ID component 1225, an analytics request indication component 1230, an analytics indication component 1235, a parameter identification component 1240, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105 or a core network 130, between devices, components, or virtualized components associated with a network entity 105 or a core network 130), or any combination thereof.

The communications manager 1220 may support wireless communication at a first device in accordance with examples as disclosed herein. The set ID component 1225 may be configured as or otherwise support a means for obtaining, from a second device, a first message that indicates a set of multiple set IDs associated with network analytics of a core network of a wireless communications system, where each set ID of the set of multiple set IDs corresponds to a respective operation and a respective set of parameters. The analytics request indication component 1230 may be configured as or otherwise support a means for obtaining, from a third device, a second message that indicates a request for network analytics associated with a set ID of the set of multiple set IDs in accordance with the respective operation and the respective set of parameters that correspond to the set ID. The analytics indication component 1235 may be configured as or otherwise support a means for outputting, to the third device in response to the request, a third message that indicates the network analytics associated with the respective operation and the respective set of parameters that correspond to the set ID.

In some examples, the analytics request indication component 1230 may be configured as or otherwise support a means for outputting a fourth message via an Naf in response to obtaining the second message that indicates the request for the network analytics, where the fourth message indicates the respective set of parameters. In some examples, the analytics indication component 1235 may be configured as or otherwise support a means for obtaining a fifth message via the Naf in response to outputting the fourth message, where the fifth message indicates the network analytics, and where outputting the third message is based on receiving the fifth message that indicates the network analytics.

In some examples, to support obtaining the second message, the set ID component 1225 may be configured as or otherwise support a means for obtaining the second message via application layer signaling, where the second message indicates the set ID. In some examples, to support obtaining the second message, the parameter identification component 1240 may be configured as or otherwise support a means for identifying the respective set of parameters that corresponds to the set ID in response to obtaining the second message, where outputting the fourth message is based on identifying the respective set of parameters.

In some examples, to support obtaining the second message, the analytics request indication component 1230 may be configured as or otherwise support a means for obtaining the second message via application layer signaling, where the second message indicates the respective set of parameters that corresponds to the set ID, and where outputting the fourth message is based on the second message indicating the respective set of parameters.

In some examples, the respective operation that corresponds to the set ID is associated with an ML model used at the second device or the third device, or both. In some examples, obtaining the second message indicating the request for network analytics is associated with the respective operation that corresponds to the set ID.

In some examples, the network analytics are based on the respective set of parameters that corresponds to the set ID. In some examples, the respective set of parameters that corresponds to the set ID is based on an SLA associated with the second device.

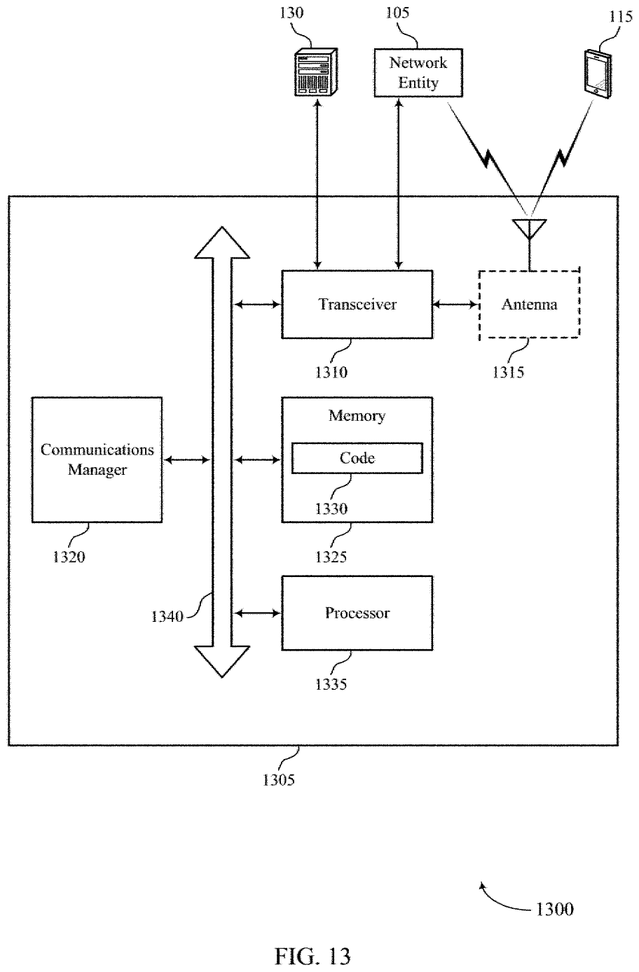

FIG. 13 illustrates a diagram of a system 1300 including a device 1305 that supports techniques for network analytics exposure from a core network of a wireless communications system in accordance with one or more aspects of the present disclosure. The device 1305 may be an example of or include the components of a device 1005, a device 1105, a network entity 105, or a core network 130 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting techniques for network analytics exposure from a core network of a wireless communications system). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a first device (e.g., the device 1305) in accordance with examples as disclosed herein. For example, the communications manager 1320 may be configured as or otherwise support a means for obtaining, from a second device, a first message that indicates a set of multiple set IDs associated with network analytics of a core network of a wireless communications system, where each set ID of the set of multiple set IDs corresponds to a respective operation and a respective set of parameters. The communications manager 1320 may be configured as or otherwise support a means for obtaining, from a third device, a second message that indicates a request for network analytics associated with a set ID of the set of multiple set IDs in accordance with the respective operation and the respective set of parameters that correspond to the set ID. The communications manager 1320 may be configured as or otherwise support a means for outputting, to the third device in response to the request, a third message that indicating the network analytics associated with the respective operation and the respective set of parameters that correspond to the set ID.

By including or configuring the communications manager 1320 in accordance with examples as described herein, the device 1305 may support techniques for improved communication reliability, reduced latency, and improved utilization of processing capability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of techniques for network analytics exposure from a core network of a wireless communications system as described herein, or the processor 1335 and the memory 1325 may be otherwise configured to perform or support such operations.

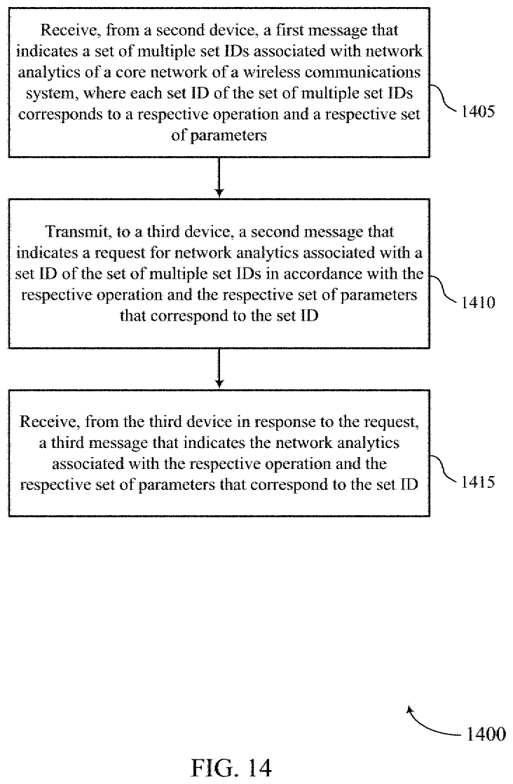

FIG. 14 illustrates a flowchart showing a method 1400 that supports techniques for network analytics exposure from a core network of a wireless communications system in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, from a second device, a first message that indicates a set of multiple set IDs associated with network analytics of a core network of a wireless communications system, where each set ID of the set of multiple set IDs corresponds to a respective operation and a respective set of parameters. The operations of 1405 may be performed in accordance with examples as disclosed herein. In some examples, aspects of the operations of 1405 may be performed by a set ID indication component 825 as described with reference to FIG. 8.

At 1410, the method may include transmitting, to a third device, a second message that indicates a request for network analytics associated with a set ID of the set of multiple set IDs in accordance with the respective operation and the respective set of parameters that correspond to the set ID. The operations of 1410 may be performed in accordance with examples as disclosed herein. In some examples, aspects of the operations of 1410 may be performed by a network analytics request component 830 as described with reference to FIG. 8.

At 1415, the method may include receiving, from the third device in response to the request, a third message that indicates the network analytics associated with the respective operation and the respective set of parameters that correspond to the set ID. The operations of 1415 may be performed in accordance with examples as disclosed herein. In some examples, aspects of the operations of 1415 may be performed by a network analytics component 835 as described with reference to FIG. 8.

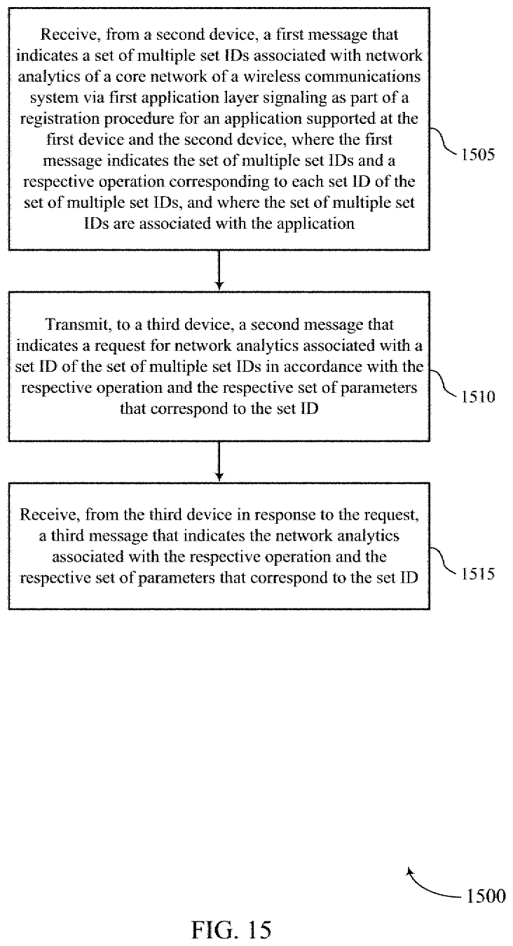

FIG. 15 illustrates a flowchart showing a method 1500 that supports techniques for network analytics exposure from a core network of a wireless communications system in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving, from a second device, a first message that indicates a set of multiple set IDs associated with network analytics of a core network of a wireless communications system via first application layer signaling as part of a registration procedure for an application supported at the first device and the second device, where the first message indicates the set of multiple set IDs and a respective operation corresponding to each set ID of the set of multiple set IDs, and where the set of multiple set IDs are associated with the application. The operations of 1505 may be performed in accordance with examples as disclosed herein. In some examples, aspects of the operations of 1505 may be performed by a set ID indication component 825 as described with reference to FIG. 8.

At 1510, the method may include transmitting, to a third device, a second message that indicates a request for network analytics associated with a set ID of the set of multiple set IDs in accordance with the respective operation and the respective set of parameters that correspond to the set ID. The operations of 1510 may be performed in accordance with examples as disclosed herein. In some examples, aspects of the operations of 1510 may be performed by a network analytics request component 830 as described with reference to FIG. 8.

At 1515, the method may include receiving, from the third device in response to the request, a third message that indicates the network analytics associated with the respective operation and the respective set of parameters that correspond to the set ID. The operations of 1515 may be performed in accordance with examples as disclosed herein. In some examples, aspects of the operations of 1515 may be performed by a network analytics component 835 as described with reference to FIG. 8.

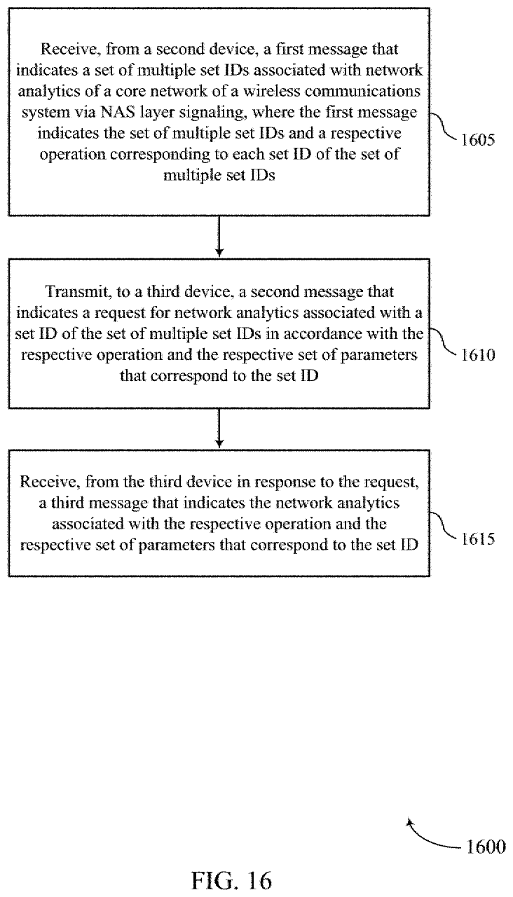

FIG. 16 illustrates a flowchart showing a method 1600 that supports techniques for network analytics exposure from a core network of a wireless communications system in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving, from a second device, a first message that indicates a set of multiple set IDs associated with network analytics of a core network of a wireless communications system via NAS layer signaling, where the first message indicates the set of multiple set IDs and a respective operation corresponding to each set ID of the set of multiple set IDs. The operations of 1605 may be performed in accordance with examples as disclosed herein. In some examples, aspects of the operations of 1605 may be performed by a set ID indication component 825 as described with reference to FIG. 8.

At 1610, the method may include transmitting, to a third device, a second message that indicates a request for network analytics associated with a set ID of the set of multiple set IDs in accordance with the respective operation and the respective set of parameters that correspond to the set ID. The operations of 1610 may be performed in accordance with examples as disclosed herein. In some examples, aspects of the operations of 1610 may be performed by a network analytics request component 830 as described with reference to FIG. 8.

At 1615, the method may include receiving, from the third device in response to the request, a third message that indicates the network analytics associated with the respective operation and the respective set of parameters that correspond to the set ID. The operations of 1615 may be performed in accordance with examples as disclosed herein. In some examples, aspects of the operations of 1615 may be performed by a network analytics component 835 as described with reference to FIG. 8.

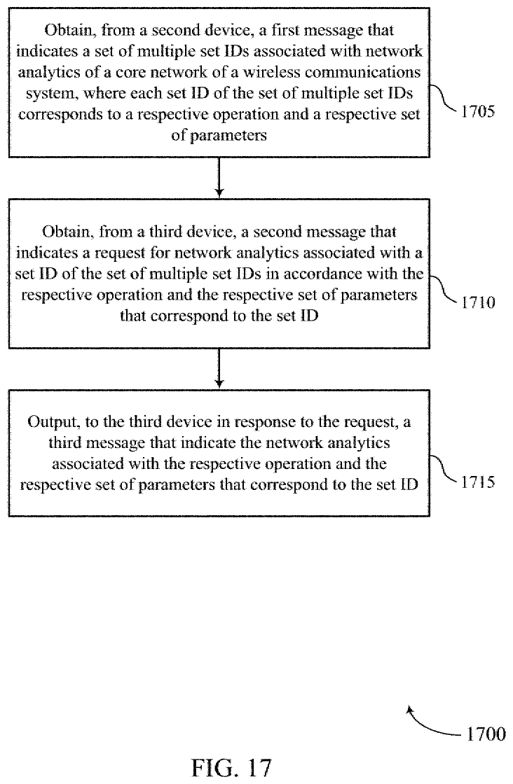

FIG. 17 illustrates a flowchart showing a method 1700 that supports techniques for network analytics exposure from a core network of a wireless communications system in accordance with one or more aspects of the present disclosure. The operations of the method 1700 may be implemented by a network entity or its components as described herein. For example, the operations of the method 1700 may be performed by a network entity or a core network as described with reference to FIGS. 1 through 5 and 10 through 13. In some examples, a network entity or a core network may execute a set of instructions to control the functional elements of the network entity or the core network, respectively, to perform the described functions. Additionally, or alternatively, the network entity or the core network may perform aspects of the described functions using special-purpose hardware.

At 1705, the method may include obtaining, from a second device, a first message that indicates a set of multiple set IDs associated with network analytics of a core network of a wireless communications system, where each set ID of the set of multiple set IDs corresponds to a respective operation and a respective set of parameters. The operations of 1705 may be performed in accordance with examples as disclosed herein. In some examples, aspects of the operations of 1705 may be performed by a set ID component 1225 as described with reference to FIG. 12.

At 1710, the method may include obtaining, from a third device, a second message that indicates a request for network analytics associated with a set ID of the set of multiple set IDs in accordance with the respective operation and the respective set of parameters that correspond to the set ID. The operations of 1710 may be performed in accordance with examples as disclosed herein. In some examples, aspects of the operations of 1710 may be performed by an analytics request indication component 1230 as described with reference to FIG. 12.

At 1715, the method may include outputting, to the third device in response to the request, a third message that indicates the network analytics associated with the respective operation and the respective set of parameters that correspond to the set ID. The operations of 1715 may be performed in accordance with examples as disclosed herein. In some examples, aspects of the operations of 1715 may be performed by an analytics indication component 1235 as described with reference to FIG. 12.

The following provides an overview of aspects of the present disclosure:
Aspect 1: A method for wireless communication at a first device, comprising: receiving, from a second device, a first message that indicates a plurality of set IDs associated with network analytics of a core network of a wireless communications system, wherein each set ID of the plurality of set IDs corresponds to a respective operation and a respective set of parameters; transmitting, to a third device, a second message that indicates a request for network analytics associated with a set ID of the plurality of set IDs in accordance with the respective operation and the respective set of parameters that correspond to the set ID; and receiving, from the third device in response to the request, a third message that indicates the network analytics associated with the respective operation and the respective set of parameters that correspond to the set ID.
Aspect 2: The method of aspect 1, wherein receiving the first message comprises: receiving the first message via first application layer signaling as part of a registration procedure for an application supported at the first device and the second device, wherein the first message indicates the plurality of set IDs and the respective operation corresponding to each set ID of the plurality of set IDs, and wherein the plurality of set IDs are associated with the application.
Aspect 3: The method of aspect 2, wherein transmitting the second message comprises: transmitting the second message via second application layer signaling, wherein the second message indicates the set ID such that an application layer of a protocol stack used at the first device is agnostic to a correspondence between each set ID and the respective set of parameters.
Aspect 4: The method of aspect 1, wherein receiving the first message comprises: receiving the first message via NAS layer signaling, wherein the first message indicates the plurality of set IDs and the respective operation corresponding to each set ID of the plurality of set IDs.
Aspect 5: The method of aspect 4, wherein the first message further indicates a UE policy associated with one or more applications supported at the first device and the second device, and each set ID of the plurality of set IDs is associated with a respective application of the one or more applications.
Aspect 6: The method of any of aspects 1, 4, and 5, wherein transmitting the second message comprises: transmitting the second message via application layer signaling, wherein the second message indicates the respective set of parameters that corresponds to the set ID.
Aspect 7: The method of aspect 6, further comprising: receiving, from a fourth device, a fourth message that indicates the plurality of set IDs and the respective set of parameters corresponding to each set ID of the plurality of set IDs, wherein transmitting the second message that indicates the request and the respective set of parameters is based at least in part on receiving the fourth message.
Aspect 8: The method of aspect 7, wherein receiving the fourth message comprises: receiving the fourth message via NAS layer signaling, wherein the fourth message further indicates a UE policy associated with one or more applications supported at the first device and the fourth device, and wherein each set ID of the plurality of set IDs is associated with a respective application of the one or more applications.
Aspect 9: The method of any of aspects 1 through 8, wherein transmitting the second message indicating the request for the network analytics is associated with performing the respective operation that corresponds to the set ID.
Aspect 10: The method of any of aspects 1 through 9, wherein the respective operation that corresponds to the set ID is associated with a ML model used at the first device or the second device, or both.
Aspect 11: The method of any of aspects 1 through 10, wherein the network analytics are based at least in part on the respective set of parameters that corresponds to the set ID.
Aspect 12: The method of any of aspects 1 through 11, wherein the respective set of parameters that corresponds to the set ID is based at least in part on a SLA associated with the second device.
Aspect 12: The method of any of aspects 1 through 11, wherein the third message comprises an indication of statistics or predictions that correspond to the network analytics associated with the respective operation to the first device.
Aspect 13: A method for wireless communication at a first device, comprising: obtaining, from a second device, a first message that indicates a plurality of set IDs associated with network analytics of a core network of a wireless communications system, wherein each set ID of the plurality of set IDs corresponds to a respective operation and a respective set of parameters; obtaining, from a third device, a second message that indicates a request for network analytics associated with a set ID of the plurality of set IDs in accordance with the respective operation and the respective set of parameters that correspond to the set ID; and outputting, to the third device in response to the request, a third message that indicates the network analytics associated with the respective operation and the respective set of parameters that correspond to the set ID.
Aspect 14: The method of aspect 13, further comprising: outputting a fourth message via a Naf in response to obtaining the second message that indicates the request for the network analytics, wherein the fourth message indicates the respective set of parameters; and obtaining a fifth message via the Naf in response to outputting the fourth message, wherein the fifth message indicates the network analytics, and wherein outputting the third message is based at least in part on receiving the fifth message that indicates the network analytics.
Aspect 15: The method of aspect 14, wherein obtaining the second message comprises: obtaining the second message via application layer signaling, wherein the second message indicates the set ID; and identifying the respective set of parameters that corresponds to the set ID in response to obtaining the second message, wherein outputting the fourth message is based at least in part on identifying the respective set of parameters.
Aspect 16: The method of aspect 14, wherein obtaining the second message comprises: obtaining the second message via application layer signaling, wherein the second message indicates the respective set of parameters that corresponds to the set ID, and wherein outputting the fourth message is based at least in part on the second message indicating the respective set of parameters.
Aspect 17: The method of any of aspects 13 through 16, wherein the respective operation that corresponds to the set ID is associated with a ML model used at the second device or the third device, or both.
Aspect 18: The method of any of aspects 13 through 17, wherein obtaining the second message indicating the request for network analytics is associated with the respective operation that corresponds to the set ID.
Aspect 19: The method of any of aspects 13 through 18, wherein the network analytics are based at least in part on the respective set of parameters that corresponds to the set ID.
Aspect 20: The method of any of aspects 13 through 19, wherein the respective set of parameters that corresponds to the set ID is based at least in part on a SLA associated with the second device.
Aspect 21: An apparatus for wireless communication at a first device, comprising a processor; memory coupled with the processor; and instructions stored in the memory and executable by the processor to cause the apparatus to perform a method of any of aspects 1 through 12.
Aspect 22: An apparatus for wireless communication at a first device, comprising at least one means for performing a method of any of aspects 1 through 12.
Aspect 23: A non-transitory computer-readable medium storing code for wireless communication at a first device, the code comprising instructions executable by a processor to perform a method of any of aspects 1 through 12.
Aspect 24: An apparatus for wireless communication at a first device, comprising a processor; memory coupled with the processor; and instructions stored in the memory and executable by the processor to cause the apparatus to perform a method of any of aspects 13 through 20.
Aspect 25: An apparatus for wireless communication at a first device, comprising at least one means for performing a method of any of aspects 13 through 20.
Aspect 26: A non-transitory computer-readable medium storing code for wireless communication at a first device, the code comprising instructions executable by a processor to perform a method of any of aspects 13 through 20.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein. Please enter the following amendments to the claims:

1. An apparatus for wireless communication at a first device, comprising:
a processor;
memory coupled with the processor; and
instructions stored in the memory and executable by the processor to cause the apparatus to:
receive, from a second device, a first message that indicates a plurality of set identifiers associated with network analytics of a core network of a wireless communications system, wherein each set identifier of the plurality of set identifiers corresponds to a respective operation and a respective set of parameters;
transmit, to a third device, a second message that indicates a request for network analytics associated with a set identifier of the plurality of set identifiers in accordance with the respective operation and the respective set of parameters that correspond to the set identifier; and
receive, from the third device in response to the request, a third message that indicates the network analytics associated with the respective operation and the respective set of parameters that correspond to the set identifier.

2. The apparatus of claim 1, wherein the instructions to receive the first message are executable by the processor to cause the apparatus to:
receive the first message via first application layer signaling as part of a registration procedure for an application supported at the first device and the second device, wherein the first message indicates the plurality of set identifiers and the respective operation corresponding to each set identifier of the plurality of set identifiers, and wherein the plurality of set identifiers are associated with the application.

3. The apparatus of claim 2, wherein the instructions to transmit the second message are executable by the processor to cause the apparatus to:
transmit the second message via second application layer signaling, wherein the second message indicates the set identifier such that an application layer of a protocol stack used at the first device is agnostic to a correspondence between each set identifier and the respective set of parameters.

4. The apparatus of claim 1, wherein the instructions to receive the first message are executable by the processor to cause the apparatus to:
receive the first message via non-access stratum layer signaling, wherein the first message indicates the plurality of set identifiers and the respective operation corresponding to each set identifier of the plurality of set identifiers.

5. The apparatus of claim 4, wherein:
the first message further indicates a UE policy associated with one or more applications supported at the first device and the second device, and
each set identifier of the plurality of set identifiers is associated with a respective application of the one or more applications.

6. The apparatus of claim 1, wherein the instructions to transmit the second message are executable by the processor to cause the apparatus to:
transmit the second message via application layer signaling, wherein the second message indicates the respective set of parameters that corresponds to the set identifier.

7. The apparatus of claim 6, wherein the instructions are further executable by the processor to cause the apparatus to:
receive, from a fourth device, a fourth message that indicates the plurality of set identifiers and the respective set of parameters corresponding to each set identifier of the plurality of set identifiers, wherein transmitting the second message that indicates the request and the respective set of parameters is based at least in part on receiving the fourth message.

8. The apparatus of claim 7, wherein the instructions to receive the fourth message are executable by the processor to cause the apparatus to:
receive the fourth message via non-access stratum layer signaling, wherein the fourth message further indicates a UE policy associated with one or more applications supported at the first device and the fourth device, and wherein each set identifier of the plurality of set identifiers is associated with a respective application of the one or more applications.

9. The apparatus of claim 1, wherein transmitting the second message indicating the request for the network analytics is associated with performing the respective operation that corresponds to the set identifier.

10. The apparatus of claim 1, wherein the respective operation that corresponds to the set identifier is associated with a machine learning model used at the first device or the second device, or both.

11. The apparatus of claim 1, wherein the network analytics are based at least in part on the respective set of parameters that corresponds to the set identifier.

12. The apparatus of claim 1, wherein the respective set of parameters that corresponds to the set identifier is based at least in part on a service level agreement associated with the second device.

13. The apparatus of claim 1, wherein the third message comprises an indication of statistics or predictions that correspond to the network analytics associated with the respective operation to the first device.

14. An apparatus for wireless communication at a first device, comprising:
a processor;
memory coupled with the processor; and
instructions stored in the memory and executable by the processor to cause the apparatus to:
obtain, from a second device, a first message that indicates a plurality of set identifiers associated with network analytics of a core network of a wireless communications system, wherein each set identifier of the plurality of set identifiers corresponds to a respective operation and a respective set of parameters;
obtain, from a third device, a second message that indicates a request for network analytics associated with a set identifier of the plurality of set identifiers in accordance with the respective operation and the respective set of parameters that correspond to the set identifier; and
output, to the third device in response to the request, a third message that indicates the network analytics associated with the respective operation and the respective set of parameters that correspond to the set identifier.

15. The apparatus of claim 14, wherein the instructions are further executable by the processor to cause the apparatus to:
output a fourth message via a network application function in response to obtaining the second message that indicates the request for the network analytics, wherein the fourth message indicates the respective set of parameters; and
obtain a fifth message via the network application function in response to outputting the fourth message, wherein the fifth message indicates the network analytics, and wherein outputting the third message is based at least in part on receiving the fifth message that indicates the network analytics.

16. The apparatus of claim 15, wherein the instructions to obtain the second message are executable by the processor to cause the apparatus to:
obtain the second message via application layer signaling, wherein the second message indicates the set identifier; and
identify the respective set of parameters that corresponds to the set identifier in response to obtaining the second message, wherein outputting the fourth message is based at least in part on identifying the respective set of parameters.

17. The apparatus of claim 15, wherein the instructions to obtain the second message are executable by the processor to cause the apparatus to:
obtain the second message via application layer signaling, wherein the second message indicates the respective set of parameters that corresponds to the set identifier, and wherein outputting the fourth message is based at least in part on the second message indicating the respective set of parameters.

18. The apparatus of claim 14, wherein the respective operation that corresponds to the set identifier is associated with a machine learning model used at the second device or the third device, or both.

19. The apparatus of claim 14, wherein obtaining the second message indicating the request for network analytics is associated with the respective operation that corresponds to the set identifier.

20. The apparatus of claim 14, wherein the network analytics are based at least in part on the respective set of parameters that corresponds to the set identifier.

21-30. (canceled)
